(19) United States
(12) Patent Application Publication
(10) Pub. No.: US 2018/0032249 A1
(43) Pub. Date: Feb. 1, 2018

(54) HARDWARE TO MAKE REMOTE STORAGE ACCESS APPEAR AS LOCAL IN A VIRTUALIZED ENVIRONMENT

(71) Applicant: Microsoft Technology Licensing, LLC, Redmond, WA (US)

(72) Inventors: Vadim MAKHERVAKS, Bellevue, WA (US); Garret Buban, Redmond, WA (US)

(73) Assignee: Microsoft Technology Licensing, LLC, Redmond, WA (US)

(21) Appl. No.: 15/219,667

(22) Filed: Jul. 26, 2016

(51) Int. Cl. G06F 3/06; G06F 9/455

(52) U.S. Cl. CPC G06F 3/061; G06F 3/0688; G06F 3/0655; G06F 3/0667; G06F 9/45558; G06F 2009/45583

(57) ABSTRACT

A host computer includes a virtual machine including a device-specific nonvolatile memory interface (NVMI). A nonvolatile memory virtualization abstraction layer (NVMVAL) hardware device communicates with the device-specific NVMI of the virtual machine. A NVMVAL driver is executed by the host computer and communicates with the NVMVAL hardware device. The NVMVAL hardware device advertises a local NVM device to the device-specific NVMI of the virtual machine. The NVMVAL hardware device and the NVMVAL driver are configured to virtualize access by the virtual machine to remote NVM that is remote from the virtual machine as if the remote NVM is local to the virtual machine.

### FIELD

The present disclosure relates to host computer systems, and more particularly to host computer systems including virtual machines and hardware to make remote storage access appear as local in a virtualized environment.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Virtual Machines (VM) running in a host operating system (OS) typically access hardware resources, such as storage, via a software emulation layer provided by a virtualization layer in the host OS. The emulation layer adds latency and generally reduces performance as compared to accessing hardware resources directly.

One solution to this problem involves the use of Single Root—Input Output Virtualization (SR-IOV). SR-IOV allows a hardware device such as a PCIE attached storage controller to create a virtual function for each VM. The virtual function can be accessed directly by the VM, thereby bypassing the software emulation layer of the Host OS.

While SR-IOV allows the hardware to be used directly by the VM, the hardware must be used for its specific purpose. In other words, a storage device must be used to store data. A network interface card (NIC) must be used to communicate on a network.

While SR-IOV is useful, it does not allow for more advanced storage systems that are accessed over a network. When accessing remote storage, the device function that the VM wants to use is storage but the physical device that the VM needs to use to access the remote storage is the NIC. Therefore, logic is used to translate storage commands to network commands. In one approach, logic may be located in software running in the VM and the VM can use SR-IOV to communicate with the NIC. Alternately, the logic may be run by the host OS and the VM uses the software emulation layer of the host OS.

### SUMMARY

A host computer includes a virtual machine including a device-specific nonvolatile memory interface (NVMI). A nonvolatile memory virtualization abstraction layer (NVMVAL) hardware device communicates with the device-specific NVMI of the virtual machine. A NVMVAL driver is executed by the host computer and communicates with the NVMVAL hardware device. The NVMVAL hardware device advertises a local NVM device to the device-specific NVMI of the virtual machine. The NVMVAL hardware device and the NVMVAL driver are configured to virtualize access by the virtual machine to remote NVM that is remote from the virtual machine as if the remote NVM is local to the virtual machine.

In other features, the NVMVAL hardware device and the NVMVAL driver are configured to mount a remote storage volume and to virtualize access by the virtual machine to the remote storage volume. The NVMVAL driver requests location information from a remote storage system corresponding to the remote storage volume, stores the location information in memory accessible by the NVMVAL hardware device and notifies the NVMVAL hardware device of the remote storage volume. The NVMVAL hardware device and the NVMVAL driver are configured to dismount the remote storage volume.

In other features, the NVMVAL hardware device and the NVMVAL driver are configured to write data to the remote NVM. The NVMVAL hardware device accesses memory to determine whether or not a storage location of the write data is known, sends a write request to the remote NVM if the storage location of the write data is known and contacts the NVMVAL driver if the storage location of the write data is not known. The NVMVAL hardware device and the NVMVAL driver are configured to read data from the remote NVM.

In other features, the NVMVAL hardware device accesses memory to determine whether or not a storage location of the read data is known, sends a read request to the remote NVM if the storage location of the read data is known and contacts the NVMVAL driver if the storage location of the read data is not known. The NVMVAL hardware device performs encryption using customer keys.

In other features, the NVMI comprises a nonvolatile memory express (NVMe) interface.

The NVMI performs device virtualization. The NVMI comprises a nonvolatile memory express (NVMe) interface with single root input/output virtualization (SR-IOV). The NVMVAL hardware device notifies the NVMVAL driver when an error condition occurs. The NVMVAL driver uses a protocol of the remote NVM to perform error handling. The NVMVAL driver notifies the NVMVAL hardware device when the error condition is resolved.

In other features, the NVMVAL hardware device includes a mount/dismount controller to mount a remote storage volume corresponding to the remote NVM and to dismount the remote storage volume; a write controller to write data to the remote NVM; and a read controller to read data from the remote NVM.

In other features, an operating system of the host computer includes a hypervisor and host stacks. The NVMVAL hardware device bypasses the hypervisor and the host stacks for data path operations. The NVMVAL hardware device comprises a field programmable gate array (FPGA). The NVMVAL hardware device comprises an application specific integrated circuit.

In other features, the NVMVAL driver handles control path processing for read requests from the remote NVM from the virtual machine and write requests to the remote NVM from the virtual machine. The NVMVAL hardware device handles data path processing for the read requests from the remote NVM for the virtual machine and the write requests to the remote NVM from the virtual machine. The NVMI comprises a nonvolatile memory express (NVMe) interface with single root input/output virtualization (SR-IOV).

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a host computer including virtual machines and a nonvolatile memory virtualization abstraction layer (NVMVAL) hardware device according to the present disclosure.

FIG. 2 is a functional block diagram of an example of a NVMVAL hardware device according to the present disclosure.

FIG. 3 is a flowchart illustrating an example of a method for mounting and dismounting a remote storage volume according to the present disclosure.

FIG. 4 is a flowchart illustrating an example of a method for writing data from the virtual machine to the remote storage volume according to the present disclosure.

FIG. 5 is a flowchart illustrating an example of a method for reading data from the remote storage volume according to the present disclosure.

FIG. 6 is a flowchart illustrating an example of a method for error handling during a read or write data flow according to the present disclosure.

FIG. 7 is a functional block diagram of an example of a system architecture including the NVMVAL hardware device according to the present disclosure.

FIG. 8 is a functional block diagram of an example of virtualization model of a virtual machine according to the present disclosure.

FIG. 9 is a functional block diagram of an example of virtualization of local NVMe devices according to the present disclosure.

FIG. 10 is a functional block diagram of an example of namespace virtualization according to the present disclosure.

FIG. 11 is a functional block diagram of an example of virtualization of local NVM according to the present disclosure.

FIG. 12 is a functional block diagram of an example of NVM access isolation according to the present disclosure.

FIGS. 13A and 13B are functional block diagrams of an example of virtualization of remote NVMe access according to the present disclosure.

FIGS. 14A and 14B are functional block diagrams of another example of virtualization of remote NVMe access according to the present disclosure.

FIG. 15 is a functional block diagram of an example illustrating virtualization of access to remote NVM according to the present disclosure.

FIG. 16 is a functional block diagram of an example illustrating remote NVM access isolation according to the present disclosure.

FIGS. 17A and 17B are functional block diagrams of an example illustrating replication to local and remote NVMe devices according to the present disclosure.

FIGS. 18A and 18B are functional block diagrams of an example illustrating replication to local and remote NVM according to the present disclosure.

FIGS. 19A and 19B are functional block diagrams illustrating an example of virtualized access to a server for a distributed storage system according to the present disclosure.

FIGS. 20A and 20B are functional block diagrams illustrating an example of virtualized access to a server for a distributed storage system with cache according to the present disclosure.

FIG. 21 is a functional block diagram illustrating an example of a store and forward model according to the present disclosure.

FIG. 22 is a functional block diagram illustrating an example of a RNIC direct access model according to the present disclosure.

FIG. 23 is a functional block diagram illustrating an example of a cut-through model according to the present disclosure.

FIG. 24 is a functional block diagram illustrating an example of a fully integrated model according to the present disclosure.

FIGS. 25A-25C are a functional block diagram and flowchart illustrating an example of a high level disk write flow according to the present disclosure.

FIGS. 26A-26C are a functional block diagram and flowcharts illustrating an example of a high level disk read flow according to the present disclosure.

In the drawings, reference numbers may be reused to identify similar and/or identical elements.

### DESCRIPTION

Datacenters require low latency access to NVM stored on persistent memory devices such as flash storage and hard disk drives (HDDs). Flash storage in datacenters may also be used to store data to support virtual machines (VMs). Flash devices have higher throughput and lower latency as compared to HDDs.

Existing storage software stacks in a host operating system (OS) such as Windows or Linux were originally optimized for HDD. However, HDDs typically have several milliseconds of latency for input/output (IO) operations. Because of the high latency of the HDDs, the focus on code efficiency of the storage software stacks was not the highest priority. With the cost efficiency improvements of flash memory and the use of flash storage and non-volatile memory as the primary backing storage for infrastructure as a service (IaaS) storage or the caching of IaaS storage, shifting focus to improve the performance of the IO stack may provide an important advantage for hosting VMs.

Device-specific standard storage interfaces such as but not limited to nonvolatile memory express (NVMe) have been used to improve performance. Device-specific standard storage interfaces are a relatively fast way of providing the VMs access to flash storage devices and other fast memory devices. Both Windows and Linux ecosystems include device-specific NVMIs to provide high performance storage to VMs and to applications.

Leveraging device-specific NVMIs provides the fastest path into the storage stack of the host OS. Using device-specific NVMIs as a front end to nonvolatile storage will improve the efficiency of VM hosting by using the most optimized software stack for each OS and by reducing the total local CPU load for delivering storage functionality to the VM.

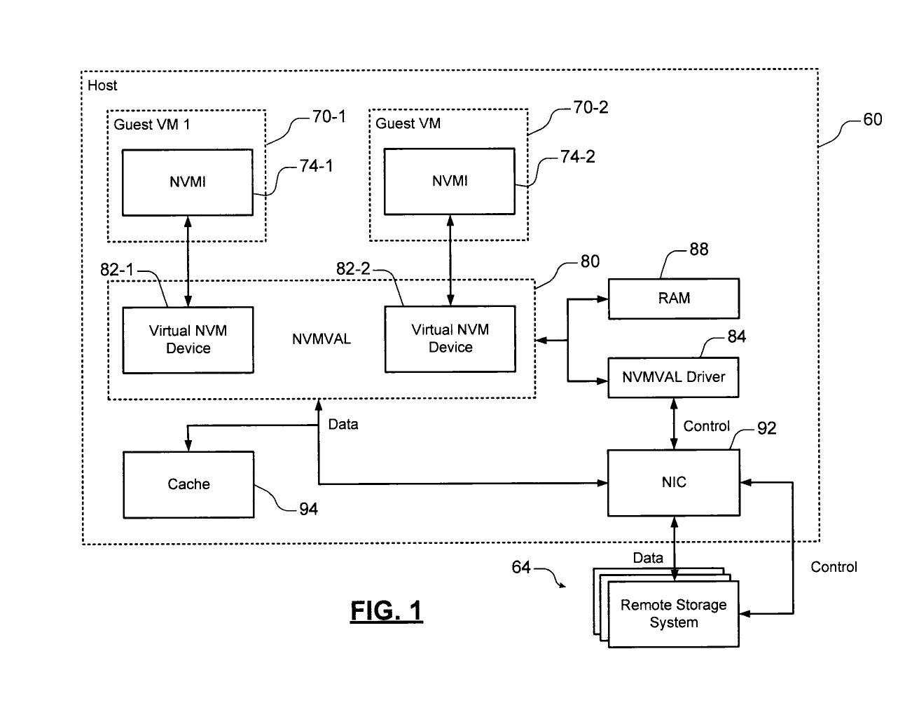

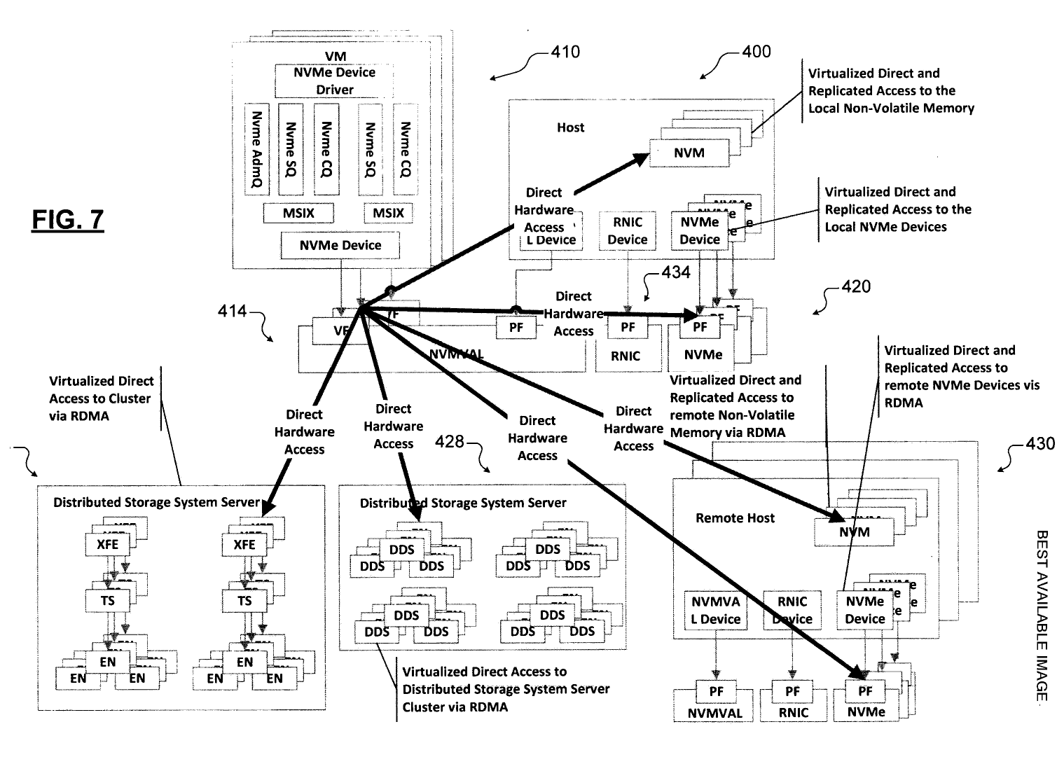

The computer system according to the present disclosure uses a hardware device to act as a nonvolatile memory storage virtualization abstraction layer (NVMVAL). In the foregoing description, FIGS. 1-6 describe an example of an architecture, a functional block diagram of nonvolatile memory storage virtualization abstraction layer (NVMVAL) hardware device, and examples of flows for mount/dismount, read and write, and error handling processes. FIGS. 7-28C present additional use cases.

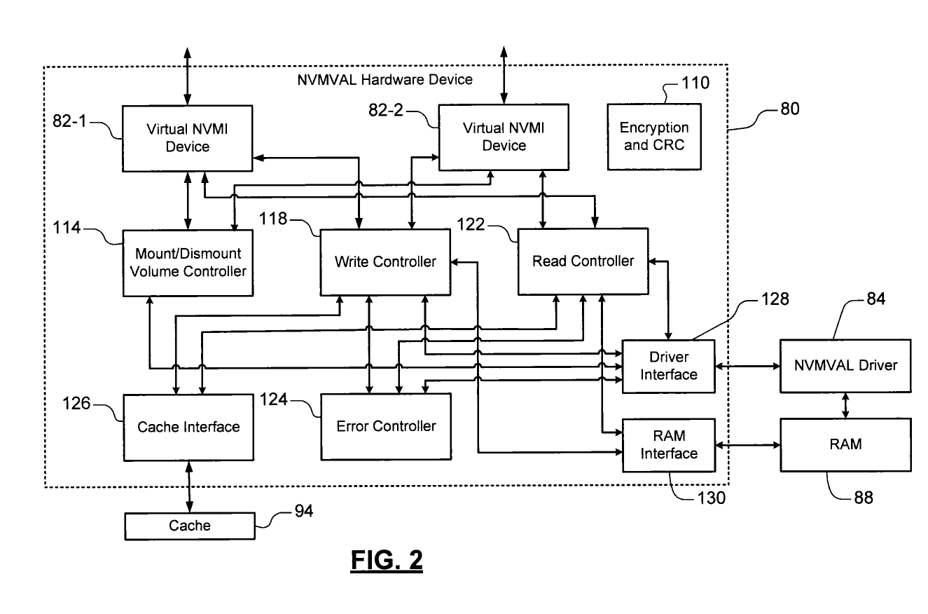

Referring now to FIGS. 1-2, a host computer 60 and one or more remote storage systems 64 are shown. The host computer 60 runs a host operating system (OS). The host computer 60 includes one or more virtual machines (VMs) 70-1, 70-2, . . . (collectively VMs 70). The VMs 70-1 and 70-2 include device-specific nonvolatile memory interfaces (NVMIs) 74-1 and 74-2, respectively (collectively device-specific NVMIs 74). In some examples, the device-specific NVMI 74 performs device virtualization.

For example only, the device-specific NVMI 74 may include a nonvolatile memory express (NVMe) interface, although other device-specific NVMIs may be used. For example only, device virtualization in the device-specific NVMI 74 may be performed using single root input/output virtualization (SR-IOV), although other device virtualization may be used.

The host computer 60 further includes a nonvolatile memory virtualization abstraction layer (NVMVAL) hardware device 80. The NVMVAL hardware device 80 advertises a device-specific NVMI to be used by the VMs 70 associated with the host computer 60. The NVMVAL hardware device 80 abstracts actual storage and/or networking hardware and the protocols used for communication with the actual storage and/or networking hardware. This approach eliminates the need to run hardware and protocol specific drivers inside of the VMs 70 while still allowing the VMs 70 to take advantage of the direct hardware access using device virtualization such as SR-IOV.

In some examples, the NVMVAL hardware device 80 includes an add-on card that provides the VM 70 with a device-specific NVMI with device virtualization. In some examples, the add-on card is a peripheral component interconnect express (PCIE) add-on card. In some examples, the device-specific NVMI with device virtualization includes an NVMe interface with direct hardware access using SR-IOV. In some examples, the NVMe interface allows the VM to directly communicate with hardware bypassing a host OS hypervisor (such as Hyper-V) and host stacks for data path operations.

The NVMVAL hardware device 80 can be implemented using a field programmable gate array (FPGA) or application specific integrated circuit (ASIC). The NVMVAL hardware device 80 is programmed to advertise one or more virtual nonvolatile memory interface (NVMI) devices 82-1 and 82-2 (collectively NVMI devices 82). In some examples, the virtual NVMI devices 82 are virtual nonvolatile memory express (NVMe) devices. The NVMVAL hardware device 80 supports device virtualization so separate VMs 70 running in the host OS can access the NVMVAL hardware device 80 independently. The VMs 70 can interact with NVMVAL hardware device 80 using standard NVMI drivers such as NVMe drivers. In some examples, no specialized software is required in the VMs 70.

The NVMVAL hardware device 80 works with a NVMVAL driver 84 running in the host OS to store data in one of the remote storage systems 64. The NVMVAL driver 84 handles control flow and error handling functionality. The NVMVAL hardware device 80 handles the data flow functionality.

The host computer 60 further includes random access memory 88 that provides storage for the NVMVAL hardware device 80 and the NVMVAL driver 84. The host computer 60 further includes a network interface card (NIC) 92 that provides a network interface to a network (such as a local network, a wide area network, a cloud network, a distributed communications system, etc that provide connections to the one or more remote storage systems 64). The one or more remote storage systems 64 communicate with the host computer 60 via the NIC 92. In some examples, cache 94 may be provided to reduce latency during read and write access.

In FIG. 2, an example of the NVMVAL hardware device 80 is shown. The NVMVAL hardware device 80 advertises the virtual NVMI devices 82-1 and 82-2 to the VMs 74-1 and 74-2, respectively. An encryption and cyclic redundancy check (CRC) device 110 encrypts and generates and/or checks CRC for the data write and read paths. A mount and dismount controller 114 mounts one or more remote storage volumes and dismounts the remote storage volumes as needed. A write controller 118 handles processing during write data flow to the remote NVM and a read controller 122 handles processing during read data flow from the remote NVM as will be described further below. An optional cache interface 126 stores write data and read data during write cache and read cache operations, respectively, to improve latency. An error controller 124 identifies error conditions and initiates error handling by the NVMVAL driver 84. Driver and RAM interfaces 128 and 130 provide interfaces to the NVMVAL driver 84 and the RAM 88, respectively. The RAM 88 can be located on the NVMVAL driver 84, in the host computer, and can be cached on the NVMVAL driver 84.

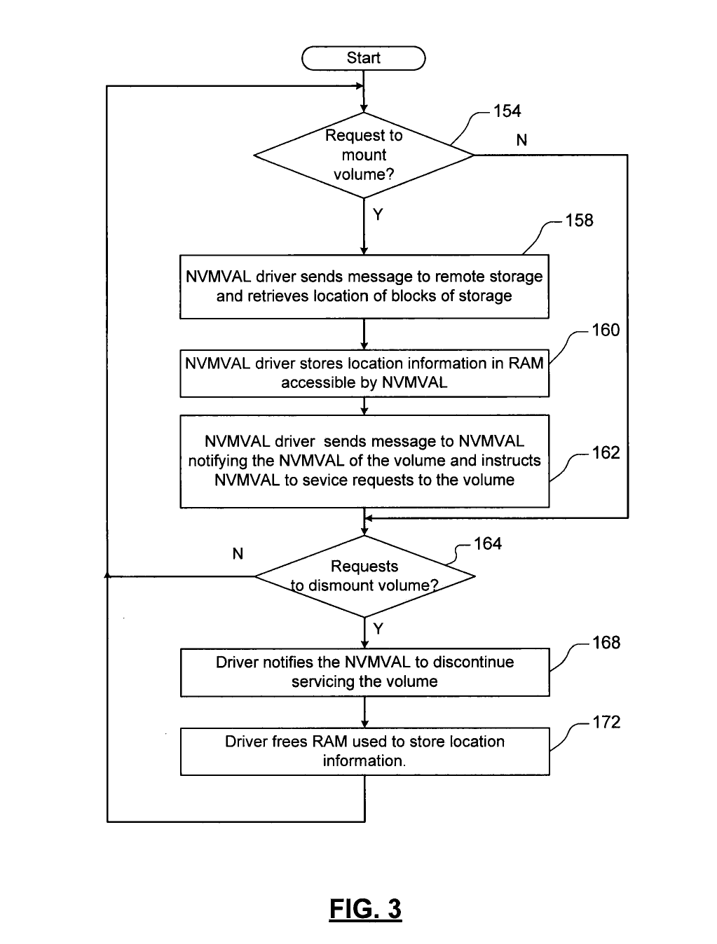

Referring now to FIGS. 3-6, methods for performing various operations are shown. In FIG. 3, a method for mounting and dismounting a remote storage volume is shown. When mounting a new remote storage volume at 154, the NVMVAL driver 84 contacts one of the remote storage systems 64 and retrieves location information of the various blocks of storage in the remote storage systems 64 at 158. The NVMVAL driver 84 stores the location information in the RAM 88 that is accessed by the NVMVAL hardware device 80 at 160. The NVMVAL driver 84 then notifies the NVMVAL hardware device 80 of the new remote storage volume and instructs the NVMVAL hardware device 80 to start servicing requests for the new remote storage volume at 162.

In FIG. 3, when receiving a request to dismount one of the remote storage volumes at 164, the NVMVAL driver 84 notifies the NVMVAL hardware device 80 to discontinue servicing requests for the remote storage volume at 168. The NVMVAL driver 84 frees corresponding memory in the RAM 88 that is used to store the location information for the remote storage volume that is being dismounted at 172.

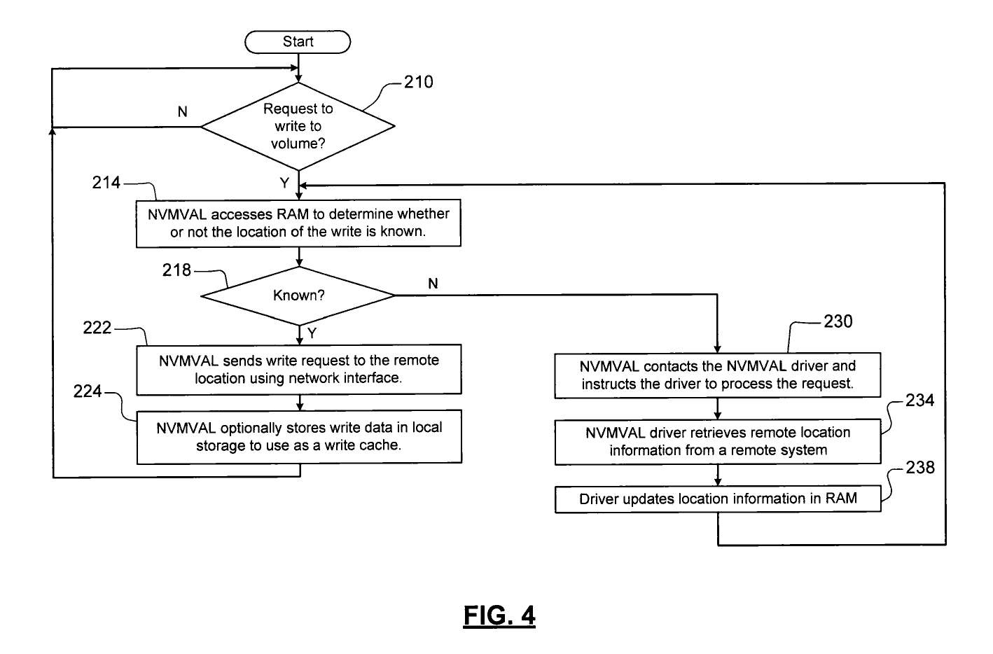

In FIG. 4, when the NVMVAL hardware device 80 receives a write request from one of the VMs 70 at 210, the NVMVAL hardware device 80 consults the location information stored in the RAM 88 to determine whether or not the remote location of the write is known at 214. If known, the NVMVAL hardware device 80 sends the write request to the corresponding one of the remote storage systems using the NIC 92 at 222. The NVMVAL hardware device 80 can optionally store the write data in a local storage device such as the cache 94 (to use as a write cache) at 224.

To accomplish 222 and 224, the NVMVAL hardware device 80 communicates directly with the NIC 92 and the cache 94 using control information provided by the NVMVAL driver 84. If the remote location information for the write is not known at 218, the NVMVAL hardware device 80 contacts the NVMVAL driver 84 and lets the NVMVAL driver 84 process the request at 230. The NVMVAL driver 84 retrieves the remote location information from one of the remote storage systems 64 at 234, updates the location information in the RAM 88 at 238, and then informs the NVMVAL hardware device 80 to try again to process the request.

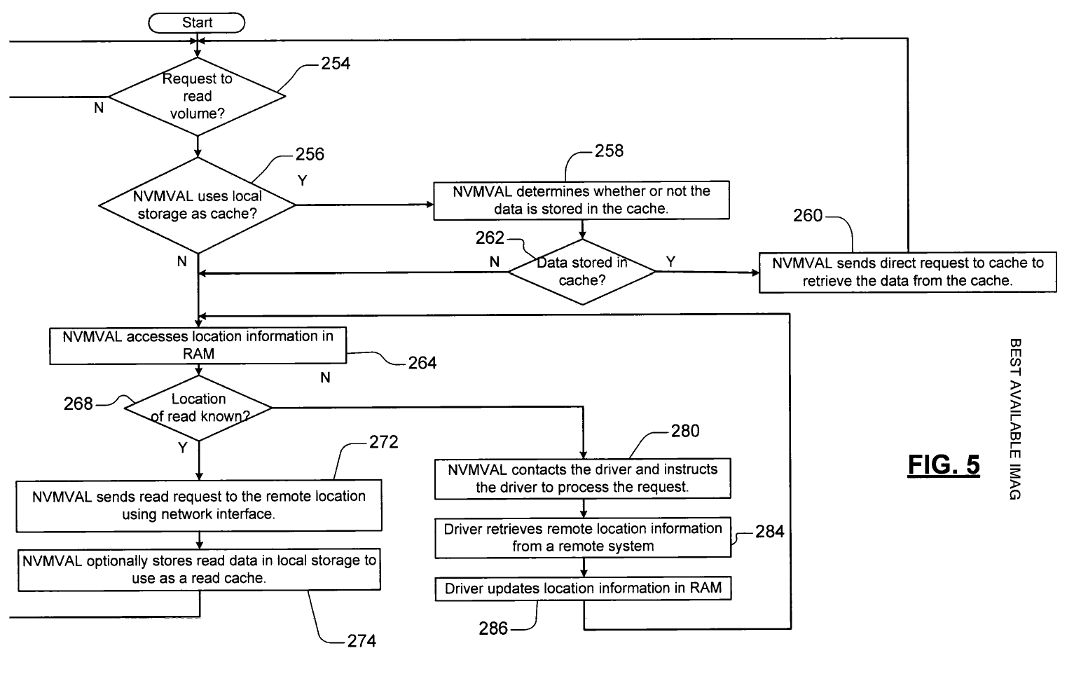

In FIG. 5, the NVMVAL hardware device 80 receives a read request from one of the VMs 70 at 254. If the NVMVAL hardware device 80 is using the cache 94 as determined at 256, the NVMVAL hardware device 80 determines whether or not the data is stored in the cache 94 at 258. If the data is stored in the cache 94 at 262, the read is satisfied from the cache 94 utilizing a direct request from the NVMVAL hardware device 80 to the cache 94 at 260.

If the data is not stored in the cache 94 at 262, the NVMVAL hardware device 80 consults the location information in the RAM 88 at 264 to determine whether or not the RAM 88 stores the remote location of the read at 268. If the RAM 88 stores the remote location of the read at 268, the NVMVAL hardware device 80 sends the read request to the remote location using the NIC 92 at 272. When the data are received, the NVMVAL hardware device 80 can optionally store the read data in the cache 94 (to use as a read cache) at 274. If the remote location information for the read is not known, the NVMVAL hardware device 80 contacts the NVMVAL driver 84 and instructs the NVMVAL driver 84 to process the request at 280. The NVMVAL driver 84 retrieves the remote location information from one of the remote storage systems 64 at 284, updates the location information in the RAM 88 at 286, and instructs the NVMVAL hardware device 80 to try again to process the request.

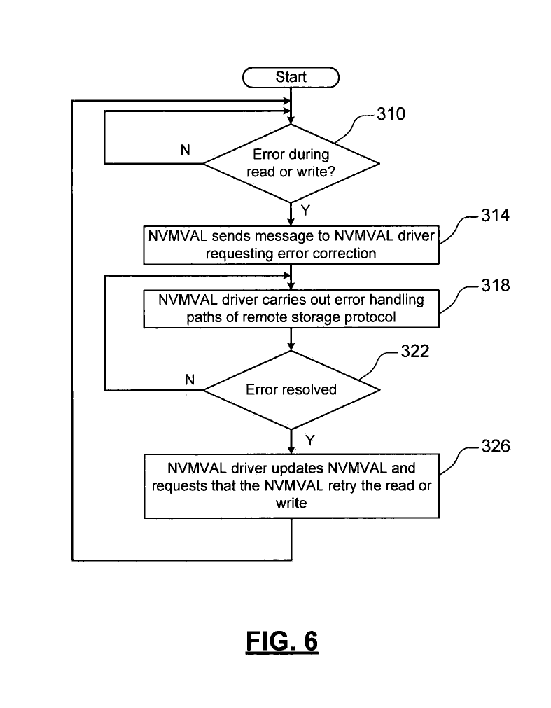

In FIG. 6, if the NVMVAL hardware device 80 encounters an error when processing a read or write request to one of the remote storage systems 64 at 310, the NVMVAL hardware device 80 sends a message instructing the NVMVAL driver 84 to correct the error condition at 314 (if possible). The NVMVAL driver 84 performs the error handling paths corresponding to a protocol of the corresponding one of the remote storage systems 64 at 318.

In some examples, the NVMVAL driver 84 contacts a remote controller service to report the error and requests that the error condition be resolved. For example only, a remote storage node may be inaccessible. The NVMVAL driver 84 asks the controller service to assign the responsibilities of the inaccessible node to a different node. Once the reassignment is complete, the NVMVAL driver 84 updates the location information in the RAM 88 to indicate the new node. When the error is resolved at 322, the NVMVAL driver 84 informs the NVMVAL hardware device 80 to retry the request at 326.

### Additional Examples and Use Cases

Referring now to FIG. 7, a host computer 400 runs a host OS and includes one or more VMs 410. The host computer 400 includes a NVMVAL hardware device 414 that provides virtualized direct access to local NVMe devices 420, one or more distributed storage system servers 428, and one or more remote hosts 430. While NVMe devices are shown in the following examples, NVMI devices may be used. Virtualized direct access is provided from the VM 410 to the remote storage cluster 424 via the RNIC 434. Virtualized direct access is also provided from the VM 410 to the distributed storage system servers 428 via the RNIC 434. Virtualized direct and replicated access is provided to remote NVM via the RNIC 434. Virtualized direct and replicated access is also provided to remote NVMe devices connected to the remote host 430 via the RNIC 434.

In some examples, the NVMVAL hardware device 414 allows high performance and low latency virtualized hardware access to a wide variety of storage technologies while completely bypassing local and remote software stacks on the data path. In some examples, the NVMVAL hardware device 414 provides virtualized direct hardware access to locally attached standard NVMe devices and NVM.

In some examples, the NVMVAL hardware device 414 provides virtualized direct hardware access to the remote standard NVMe devices and NVM utilizing high performance and low latency remote direct memory access (RDMA) capabilities of standard RDMA NICs (RNICs).

In some examples, the NVMVAL hardware device provides virtualized direct hardware access to the replicated stores using locally and remotely attached standard NVMe devices and nonvolatile memory. Virtualized direct hardware access is also provided to high performance distributed storage stacks, such distributed storage system servers.

The NVMVAL hardware device 414 does not require SR-IOV extensions to the NVMe specification. In some deployment models, the NVMVAL hardware device 414 is attached to the Pcie bus on a compute node hosting the VMs 410. In some examples, the NVMVAL hardware device 414 advertises a standard NVMI or NVMe interface. The VM perceives that it is accessing a standard directly-attached NVMI or NVMe device.

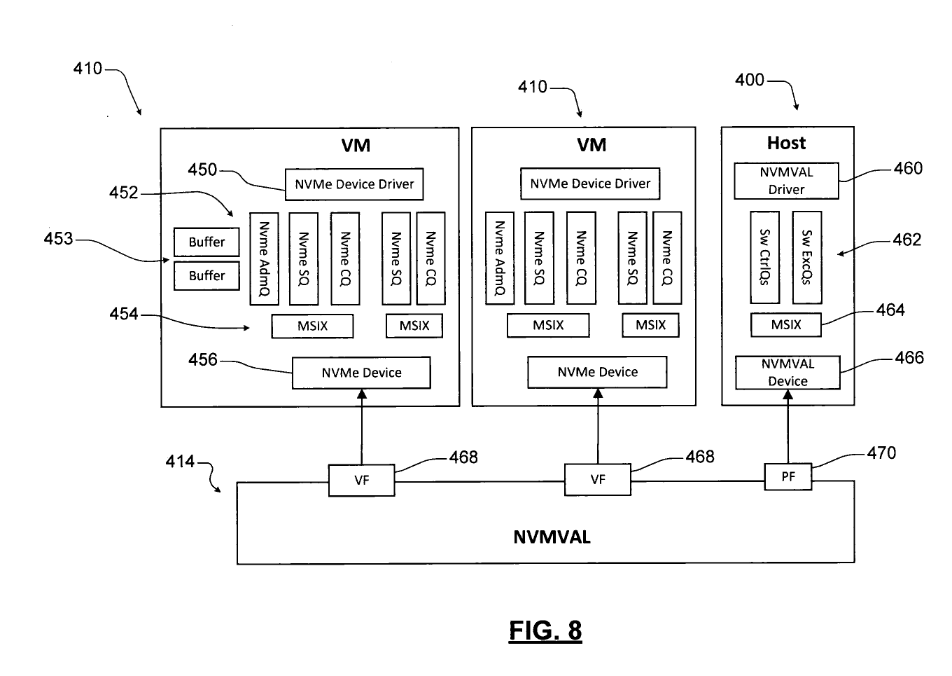

Referring now to FIGS. 8, the host computer 400 and the VMs 410 are shown in further detail. The VM 410 includes a software stack including a NVMe device driver 450, queues 452 (such as administrative queues (AdmQ), submission queues (SQ) and completion queues (CQ)), message signal interrupts (MSIX) 454 and an NVMe device interface 456.

The host computer 400 includes a NVMVAL driver 460, queues 462 such as software control and exception queues, message signal interrupts (MSIX) 464 and a NVMVAL interface 466. The NVMVAL hardware device 414 provides virtual function (VF) interfaces 468 to the VMs 410 and a physical function (PF) interface 470 to the host computer 400.

In some examples, virtual NVMe devices that are exposed by the NVMVAL hardware device 414 to the VM 410 have multiple NVMe queues and MSIX interrupts to allow the NVMe stack of the VM 410 to utilize available cores and optimize performance of the NVMe stack. In some examples, no modifications or enhancements are required to the NVMe software stack of the VM 410. In some examples, the NVMVAL hardware device 414 supports multiple VFs 468. The VF 468 is attached to the VM 410 and perceived by the VM 410 as a standard NVMe device.

In some examples, the NVMVAL hardware device 414 is a storage virtualization device that exposes NVMe hardware interfaces to the VM 410, processes and interprets the NVMe commands and communicates directly with other hardware devices to read or write the nonvolatile VM data of the VM 410.

The NVMVAL hardware device 414 is not an NVMe storage device, does not carry NVM usable for data access, and does not implement RNIC functionality to take advantage of RDMA networking for remote access. Instead the NVMVAL hardware device 414 takes advantage of functionality already provided by existing and field proven hardware devices, and communicates directly with those devices to accomplish necessary tasks, completely bypassing software stacks on the hot data path.

Software and drivers are utilized on the control path and perform hardware initialization and exception handling. The decoupled architecture allows improved performance and focus on developing value-add features of the NVMVAL hardware device 414 while reusing already available hardware for the commodity functionality.

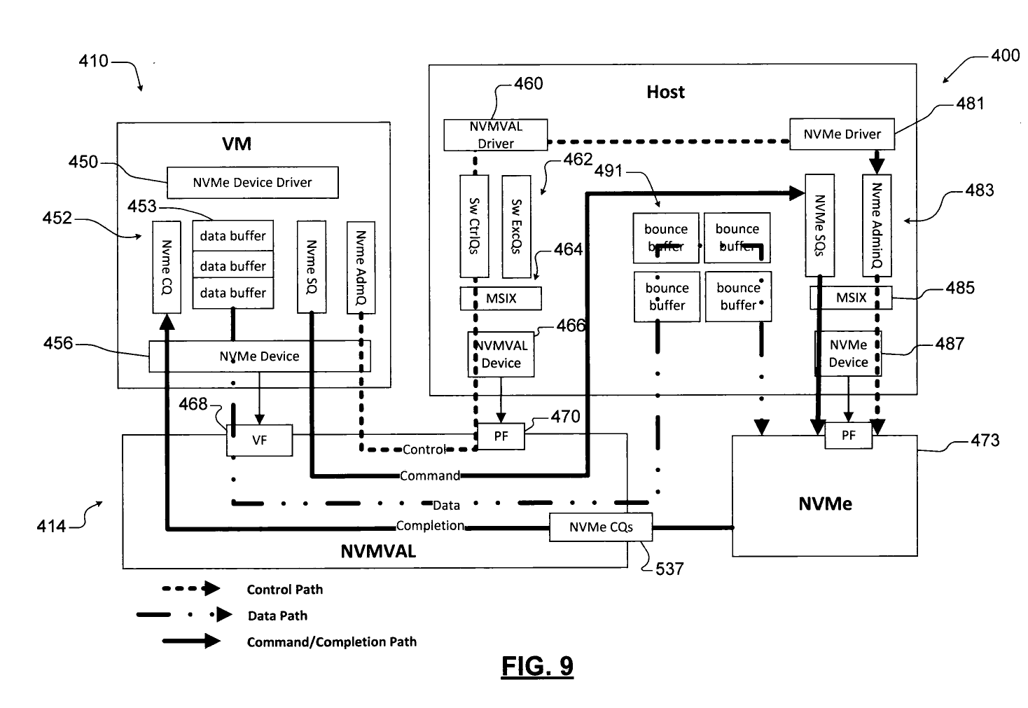

Referring now to FIGS. 9-20B, various deployment models that are enabled by the

NVMVAL hardware device 414 are shown. In some examples, the models utilize shared core logic of the NVMVAL hardware device 414, processing principles and core flows. While NVMe devices and interfaces are shown below, other device-specific NVMIs or device-specific NVMIs with device virtualization may be used.

In FIG. 9, an example of virtualization of local NVMe devices is shown. The host computer 400 includes local NVM 480, an NVMe driver 481, NVMe queues 483, MSIX 485 and an NVMe device interface 487. The NVMVAL hardware device 414 allows virtualization of standard NVMe devices 473 that do not support SR-IOV virtualization. The system in FIG. 9 removes the dependency on ratification of SR-IOV extensions to the NVMe standard (and adoption by NVMe vendors) and brings to market virtualization of the standard (existing) NVMe devices. This approach assumes the use of one or more standard, locally-attached NVMe devices and does not require any device modification. In some examples, a NVMe device driver 481 running on the host computer 400 is modified.

The NVMe standard defines submission queues (SQs), administrative queues (AdmQs) and completion queues (COs). AdmQs are used for control flow and device management. SQs and CQs are used for the data path. The NVMVAL hardware device 414 exposes and virtualizes SQs, CQs and AdmQs.

The following is a high level processing flow of NVMe commands posted to NVMe queues of the NVMVAL hardware device by the VM NVMe stack. Commands posted to the AdmQ 452 are forwarded and handled by a NVMVAL driver 460 of the NVMVAL hardware device 414 running on the host computer 400. The NVMVAL driver 460 communicates with the host NVMe driver 481 to propagate processed commands to the local NVMe devices 473. In some examples, the flow may require extension of the host NVMe driver 481.

Commands posted to the NVMe submission queue (SQ) 452 are processed and handled by the NVMVAL hardware device 414. The NVMVAL hardware device 414 resolves the local NVMe device that should handle the NVMe command and posts the command to the hardware NVMe SQ 452 of the respective locally attached NVMe device 482.

Completions of NVMe commands that are processed by local NVMe devices 487 are intercepted by the NVMe CQs 537 of the NVMVAL hardware device 414 and delivered to the VM NVMe CQs indicating completion of the respective NVMe command.

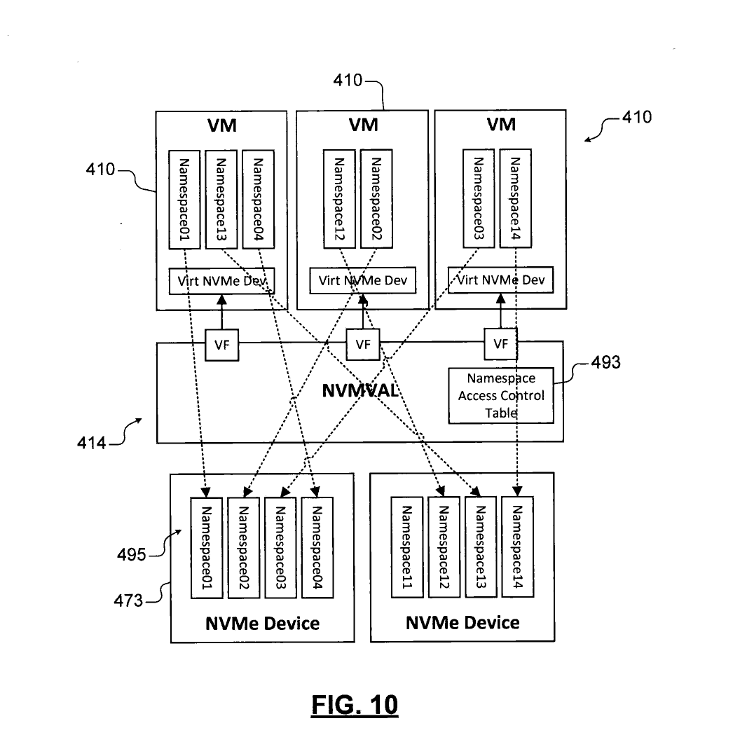

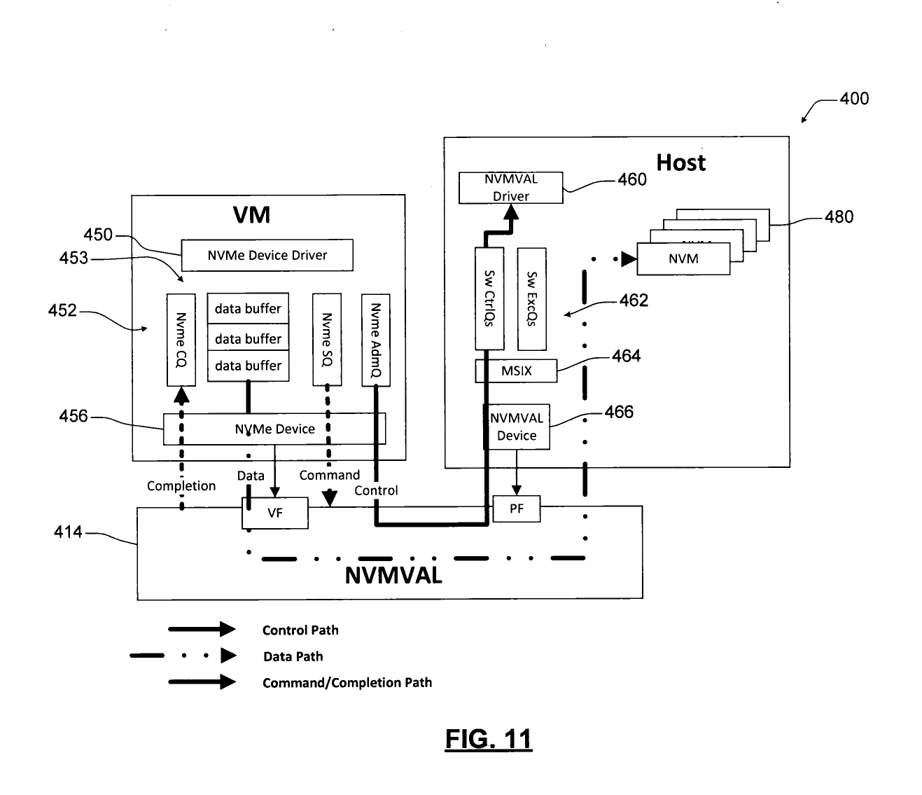

In some examples shown in FIGS. 10-11, the NVMVAL hardware device 414 copies data of NVMe commands through bounce buffers 491 in the host computer 400. This approach simplifies implementation and reduces dependencies on the behavior and implementation of RN ICs and local NVMe devices.

In FIG. 10, virtualization of local NVMe storage is enabled using NVMe namespace. The local NVMe device is configured with multiple namespaces. A management stack allocates one or more namespaces to the VM 410. The management stack uses the NVMVAL driver 460 in the host computer 400 to configure a namespace access control table 493 in the NVMVAL hardware device 414. The management stack exposes namespaces 495 of the NVMe device 473 to the VM 410 via the NVMVAL interface 466 of the host computer 400. The NVMVAL hardware device 414 also provides performance and security isolation of the local NVMe device namespace access by the VM 410 by providing data encryption with VM-provided encryption keys.

In FIG. 11, virtualization of local NVM 480 of the host computer 400 is shown. This approach allows virtualization of the local NVM 480. This model has lower efficiency than providing the VMs 410 with direct access to the files mapped to the local NVM 480. However, this approach allows more dynamic configuration, provides improved security, quality of service (QoS) and performance isolation.

Data of one of the VMs 410 is encrypted by the NVMVAL hardware device 414 using a customer-provided encryption key. The NVMVAL hardware device 414 also provides QoS of NVM access, along with performance isolation and eliminates noisy neighbor problems.

The NVMVAL hardware device 414 provides block level access and resource allocation and isolation. With extensions to the NVMe APIs, the NVMVAL hardware device 414 provides byte level access. The NVMVAL hardware device 414 processes NVMe commands, reads data from the buffers 453 in VM address space, processes data (encryption, CRC), and writes data directly to the local NVM 480 of the host computer 400. Upon completion of direct memory access (DMA) to the local NVM 480, a respective NVMe completion is reported via the NVMVAL hardware device 414 to the NVMe CQ 452 in the VM 410. The NVMe administrative flows are propagated to the NVMVAL driver 460 running on the host computer 400 for further processing.

In some examples, the NVMVAL hardware device 414 eliminates the need to flush the host CPU caches to persist data in the local NVM 480. The NVMVAL hardware driver 414 delivers data to the asynchronous DRAM refresh (ADR) domain without dependency on execution of the special instructions on the host CPU, and without relying on the VM 410 to perform actions to achieve persistent access to the local NVM 480.

In some examples, direct data input/output (DDIO) is used to allow accelerated IO processing by the host CPU via opportunistically placing IOs to the CPU cache, under assumption that IO will be promptly consumed by CPU. In some examples, when the NVMVAL hardware device 414 writes data to the local NVM 480, the data targeting the local NVM 480 is not stored to the CPU cache.

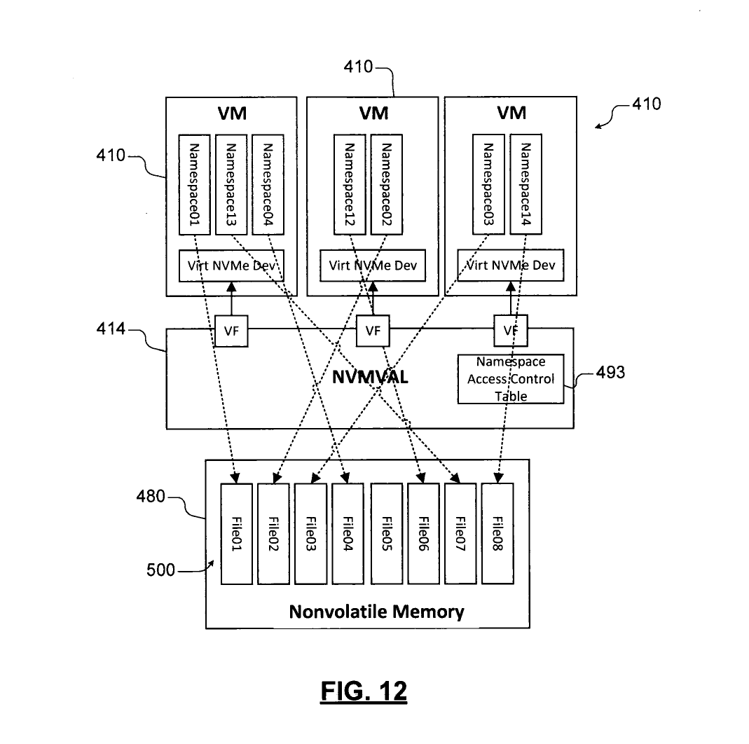

In FIG. 12, virtualization of the local NVM 480 of the host computer 400 is enabled using files 500 created via existing FS extensions for the local NVM 480. The files 500 are mapped to the NVMe namespaces. The management stack allocates one or more NVM-mapped files for the VM 410, maps those to the corresponding NVMe namespaces, and uses the NVMVAL driver 460 to configure the NVMVAL hardware device 414 and expose/assign the NVMe namespaces to the VM 410 via the NVMe interface of the NVMVAL hardware device 414.

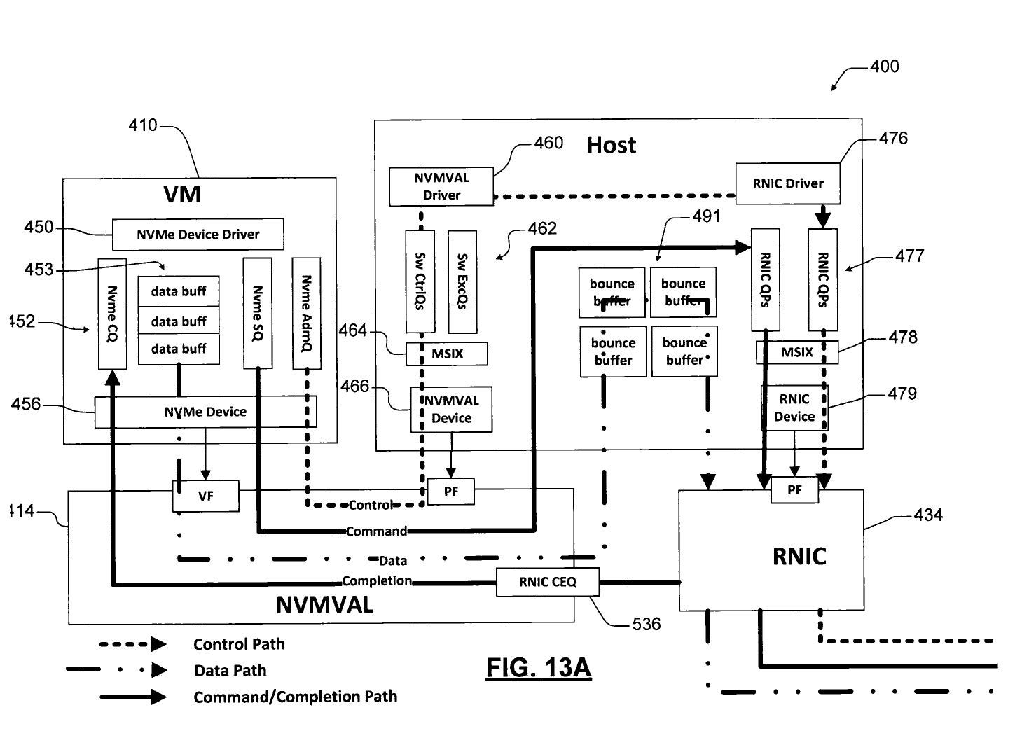

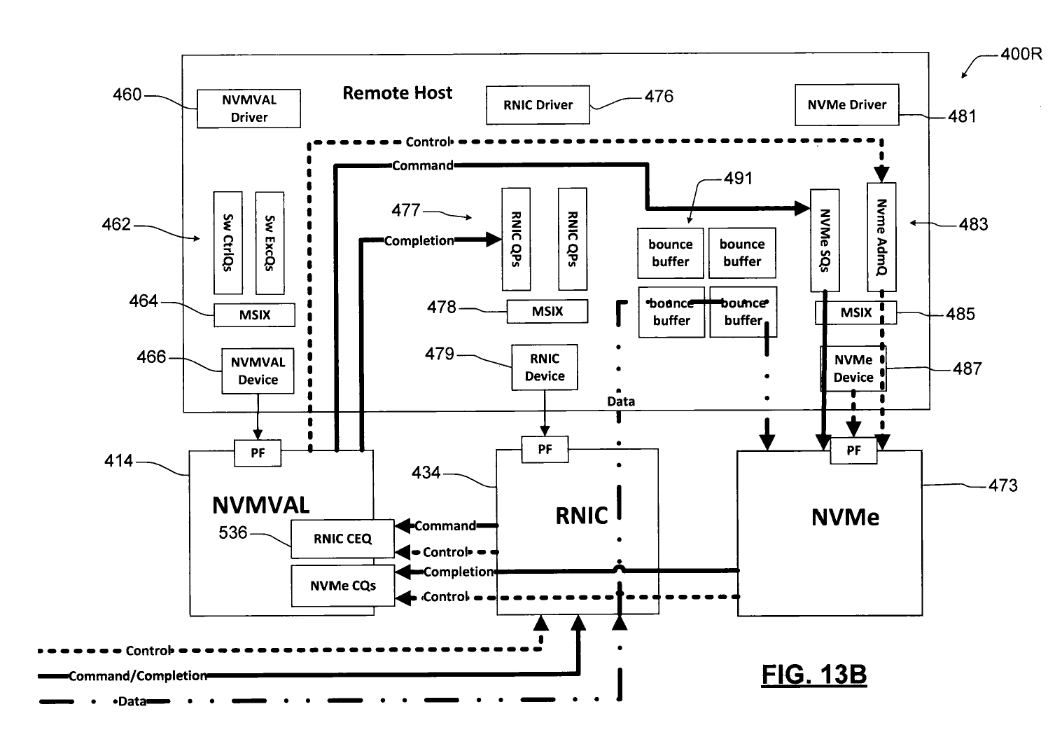

In FIGS. 13A and 13B, virtualization of remote NVMe devices 473 of a remote host computer 400R is shown. This model allows virtualization and direct VM access to the remote NVMe devices 473 via the RNIC 434 and the NVMVAL hardware device 414 of the remote host computer 400R. Additional devices such as an RNIC 434 are shown. The host computer 400 includes an RNIC driver 476, RNIC queues 477, MSIX 478 and an RNIC device interface 479. This model assumes the presence of the management stack that manages shared NVMe devices available for remote access, and handles remote NVMe device resource allocation.

The NVMe devices 473 of the remote host computer 400R are not required to support additional capabilities beyond those currently defined by the NVMe standard, and are not required to support SR-IOV virtualization. The NVMVAL hardware device 414 of the host computer 400 uses the RNIC 434. In some examples, the RNIC 434 is accessible via a Pcie bus and enables communication with the NVMe devices 473 of the remote host computer 400R.

In some examples, the wire protocol used for communication is compliant with the definition of NVMe-over-Fabric. Access to the NVMe devices 473 of the remote host computer 400R does not include software on the hot data path. NVMe administration commands are handled by the NVMVAL driver 460 running on the host computer 400 and processed commands are propagated to the NVMe device 473 of the remote host computer 400R when necessary.

NVMe commands (such as disk read/disk write) are sent to the remote node using NVMe-over-Fabric protocol, handled by the NVMVAL hardware device 414 of the remote host computer 400R at the remote node, and placed to the respective NVMe Qs 483 of the NVMe devices 473 of the remote host computer 400R.

Data is propagated to the bounce buffers 491 in the remote host computer 400R using RDMA read/write, and referred by the respective NVMe commands posted to the NVMe Qs 483 of the NVMe device 473 at the remote host computer 400R.

Completions of NVMe operations on the remote node are intercepted by the NVMe CQ 536 of the NVMVAL hardware device 414 of the remote host computer 400R and sent back to the initiating node. The NVMVAL hardware device 414 at the initiating node processes completion and signals NVMe completion to the NVMe CQ 452 in the VM 410.

The NVMVAL hardware device 414 is responsible for QoS, security and fine grain access control to the NVMe devices 473 of the remote host computer 400R. As can be appreciated, the NVMVAL hardware device 414 shares a standard NVMe device with multiple VMs running on different nodes. In some examples, data stored on the shared NVMe devices 473 of the remote host computer 400R is encrypted by the NVMVAL hardware device 414 using customer provided encryption keys.

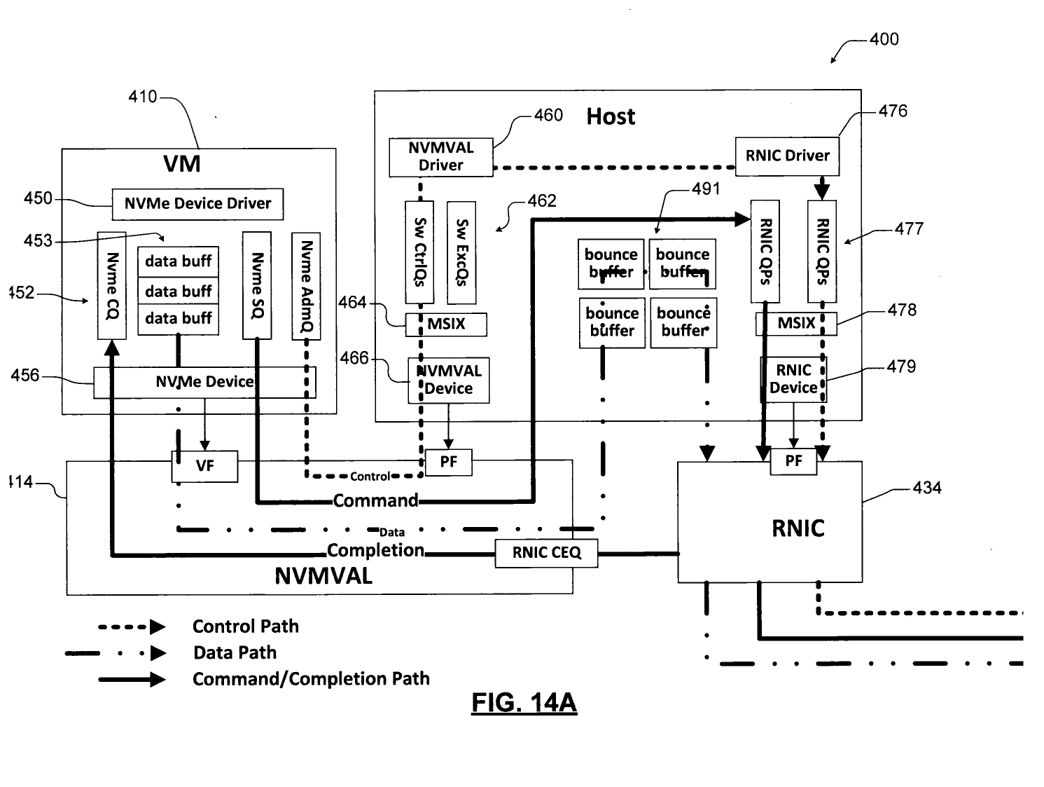

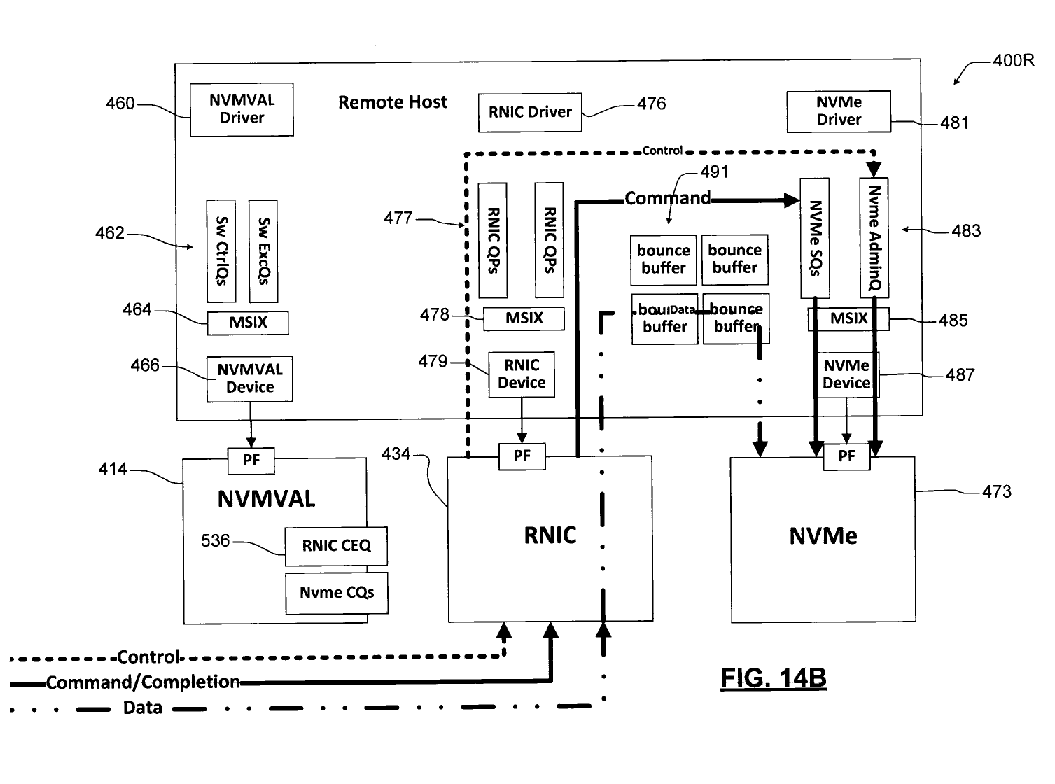

Referring now to FIGS. 14A and 14B, virtualization of the NVMe devices 473 of the remote host computer 400R may be performed in a different manner. Virtualization of remote and shared NVMe storage is enabled using NVMe namespace. The NVMe devices 473 of the remote host computer 400R are configured with multiple namespaces. The management stack allocates one of more namespaces from one or more of the NVMe devices 473 of the remote host computer 400R to the VM 410. The management stack uses NVMVAL driver 460 to configure the NVMVAL hardware device 414 and to expose/assign NVMe namespaces to the VM 410 via the NVMe interface 456. The NVMVAL hardware device 414 provides performance and security isolation of the access to the NVMe device 473 of the remote host computer 400R.

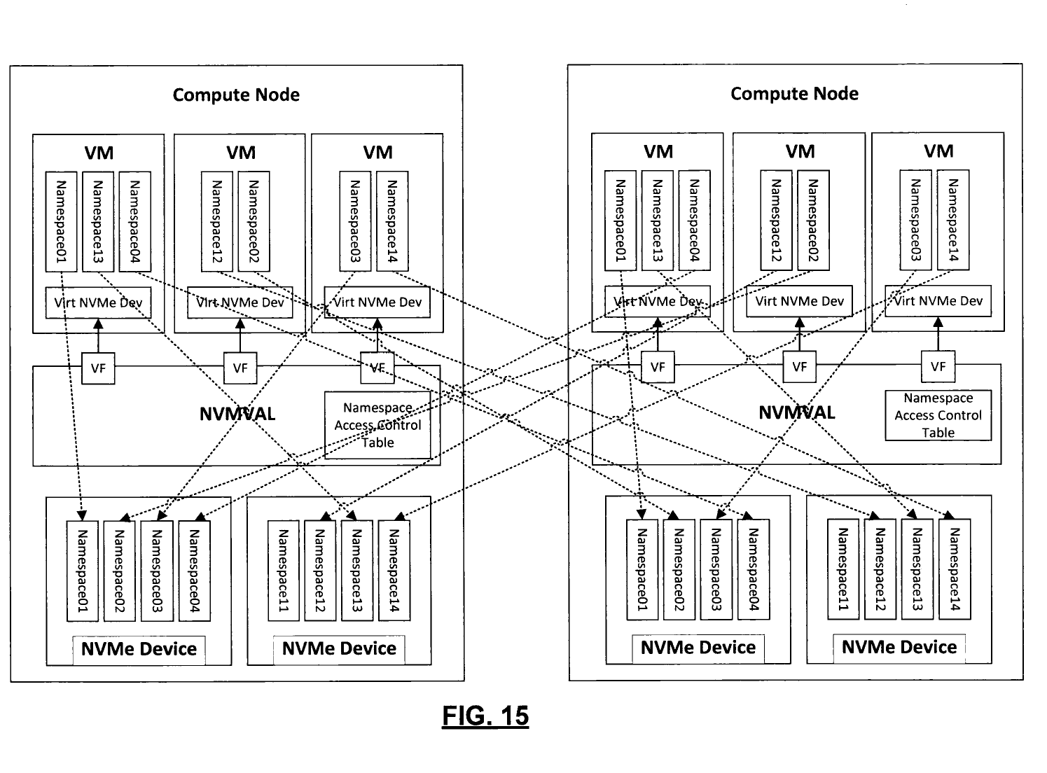

Referring now to FIGS. 15A and 15B, virtualization of remote NVM is shown. This model allows virtualization and access to the remote NVM directly from the virtual machine 410. The management stack manages cluster-wide NVM resources available for the remote access.

Similar to local NVM access, this model provides security and performance access isolation. Data of the VM 410 is encrypted by the NVMVAL hardware device 414 using customer provided encryption keys. The NVMVAL hardware device 414 uses the RNIC 434 accessible via Pcie bus for communication with the NVM 480 associated with the remote host computer 400R.

In some examples, the wire protocol used for communication is a standard RDMA protocol. The remote NVM 480 is accessed using RDMA read and RDMA write operations, respectively, mapped to the disk read and disk write operations posted to the NVMe Qs 452 in the VM 410.

The NVMVAL hardware device 414 processes NVMe commands posted by the VM 410, reads data from the buffers 453 in the VM address space, processes data (encryption, CRC), and writes data directly to the NVM 480 on the remote host computer 400R using RDMA operations. Upon completion of the RDMA operation (possibly involving additional messages to ensure persistence), a respective NVMe completion is reported via the NVMe CQ 452 in the VM 410. NVMe administration flows are propagated to the NVMVAL driver 460 running on the host computer 400 for further processing.

The NVMVAL hardware device 414 is utilized only on the local node providing an SR-IOV enabled NVMe interface to the VM 410 to allow direct hardware access, and directly communicating with the RNIC 434 (Pcie attached) to communicate with the remote node using the RDMA protocol. On the remote node, the NVMVAL hardware device 414 of the remote host computer 400R is not used to provide access to the NVM 480 of the remote host computer 400R. Access to the NVM is performed directly using the RNIC 434 of the remote host computer 400R.

In some examples, the NVMVAL hardware device 414 of the remote host computer 400R may be used as an interim solution in some circumstances. In some examples, the NVMVAL hardware device 414 provides block level access and resource allocation and isolation. In other examples, extensions to the NVMe APIs are used to provide byte level access.

Data can be delivered directly to the ADR domain on the remote node without dependency on execution of special instructions on the CPU, and without relying on the VM 410 to achieve persistent access to the NVM.

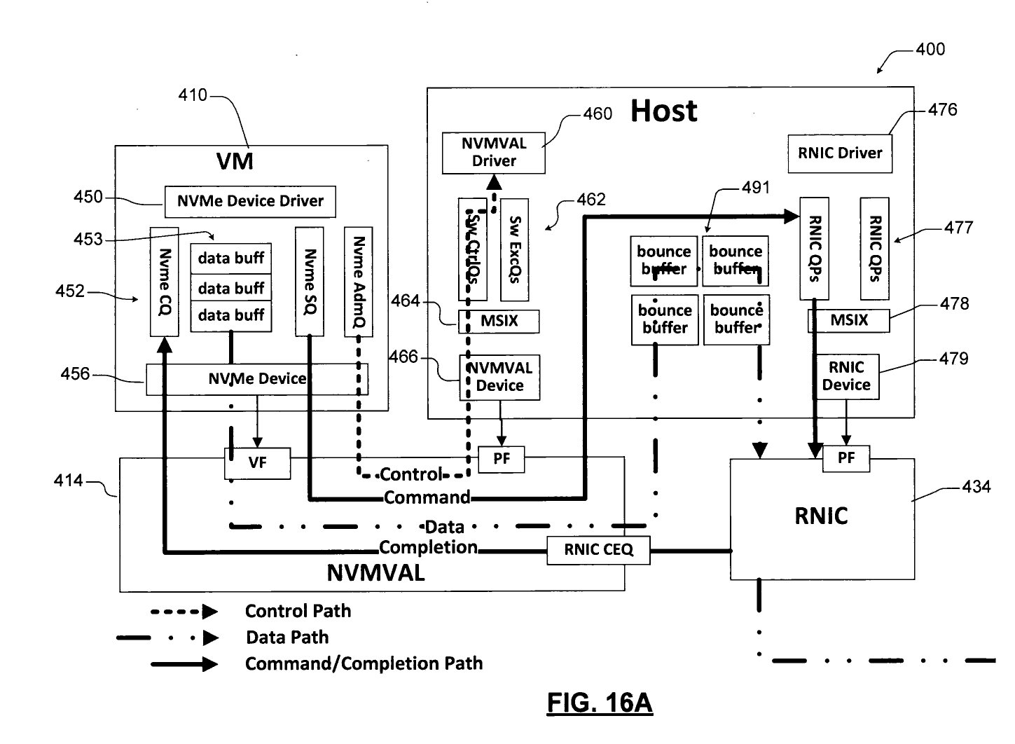

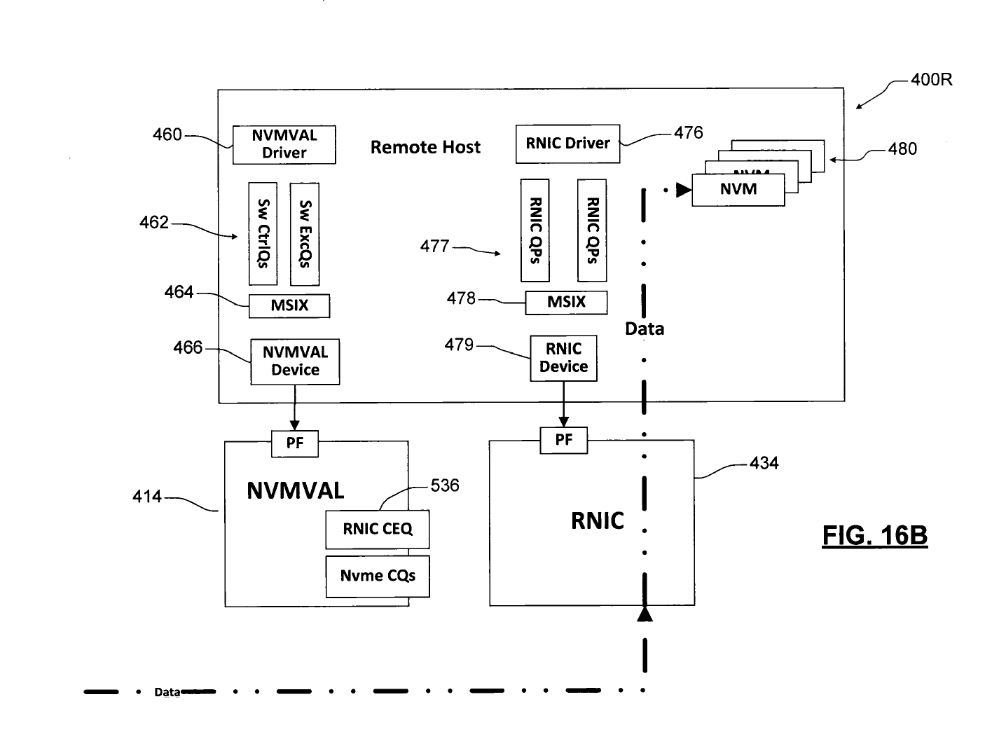

Referring now to FIG. 16, remote NVM access isolation is shown. Virtualization of remote NVM is conceptually similar to virtualization of access to the local NVM. Virtualization is based on FS extensions for NVM and mapping files to the NVMe namespaces. In some examples, the management stack allocates and manages NVM files and NVMe namespaces, correlation of files to namespaces, access coordination and NVMVAL hardware device configuration.

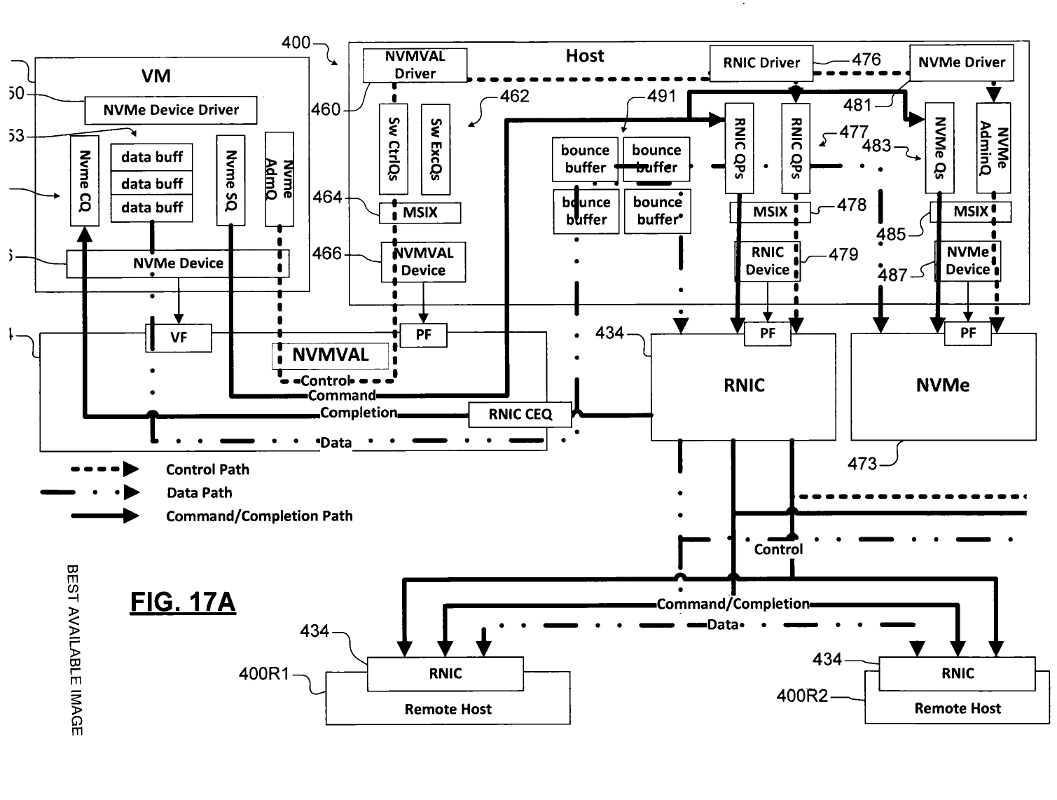

Referring now to FIGS. 17A and 17B, replication to the local NVMe devices 473 of the host computer 400 and NVMe devices 473 of the remote host computer 400R is shown. This model allows virtualization and access to the local and remote NVMe devices 473 directly from the VM 410 along with data replication.

The NVMVAL hardware device 414 accelerates data path operations and replication across local NVMe devices 473 and one or more NVMe devices 473 of the remote host computer 400R. Management, sharing and assignment of the resources of the local and remote NVMe devices 473, along with health monitoring and failover is the responsibility of the management stack in coordination with the NVMVAL driver 460.

This model relies on the technology and direct hardware access to the local and remote NVMe devices 473 enabled by the NVMVAL hardware device 414 and described in FIGS. 9 and 13A and 13B.

The NVMe namespace is a unit of virtualization and replication. The management stack allocates namespaces on the local and remote NVMe devices 473 and maps replication set of namespaces to the NVMVAL hardware device NVMe namespace exposed to the VM 410.

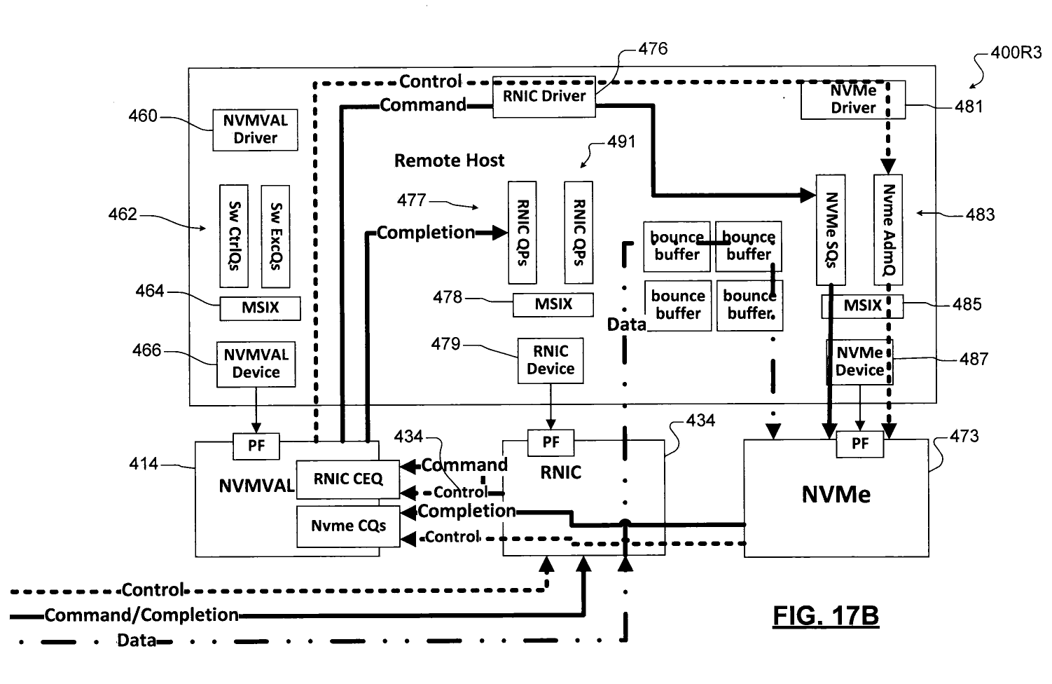

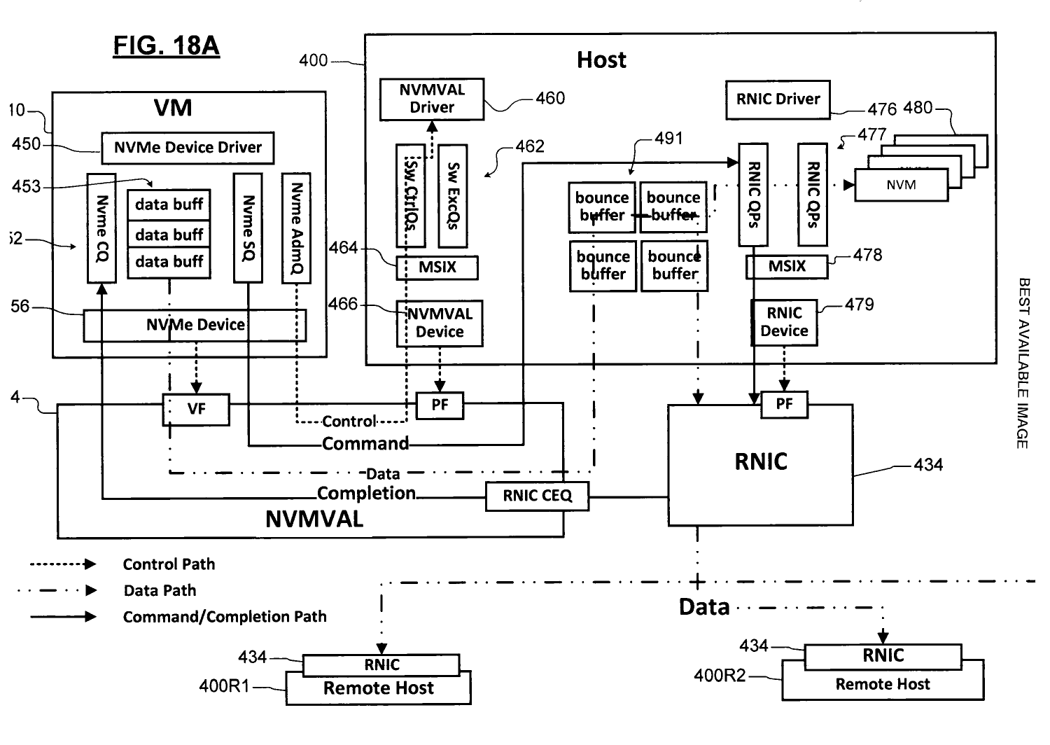

Referring now to FIGS. 18A and 18B, replication to local and remote NVMe devices 473 is shown. For example, replication to remote host computers 400R1, 400R2 and 400R3 via remote RNICs 471 of the remote host computers 400R1, 400R2 and 400R3, respectively, is shown. Disk write commands posted by the VM 410 to the NVMVAL hardware device NVMe COs 452 are processed by the NVMVAL hardware device 414 and replicated to the local and remote NVMe devices 473 associated with corresponding NVMVAL hardware device NVMe namespace. Upon completion of replicated commands, the NVMVAL hardware device 414 reports completion of the disk write operation to the NVMe CQ 452 in address space of the VM 410.

Failure is detected by the NVMVAL hardware device 414 and reported to the management stack via the NVMVAL driver 460. Exception handling and failure recovery is responsibility of the software stack.

Disk read commands posted by the VM 410 to the NVMe SQs 452 are forwarded to one of the local or remote NVMe devices 473 holding a copy of the data. Completion of the read operation is reported to the VM 410 via the NVMVAL hardware device NVMe CQ 537.

This model allows virtualization and access to the local and remote NVM directly from the VM 410, along with data replication. This model is very similar to the replication of the data to the local and remote NVMe Devices described in FIGS. 18A and 18B only using NVM technology instead.

This model relies on the technology and direct hardware access to the local and remote NVM enabled by the NVMVAL hardware device 414 and described in FIGS. 12 and 16, respectively. This model also provides platform dependencies and solutions discussed in FIGS. 12 and 16, respectively.

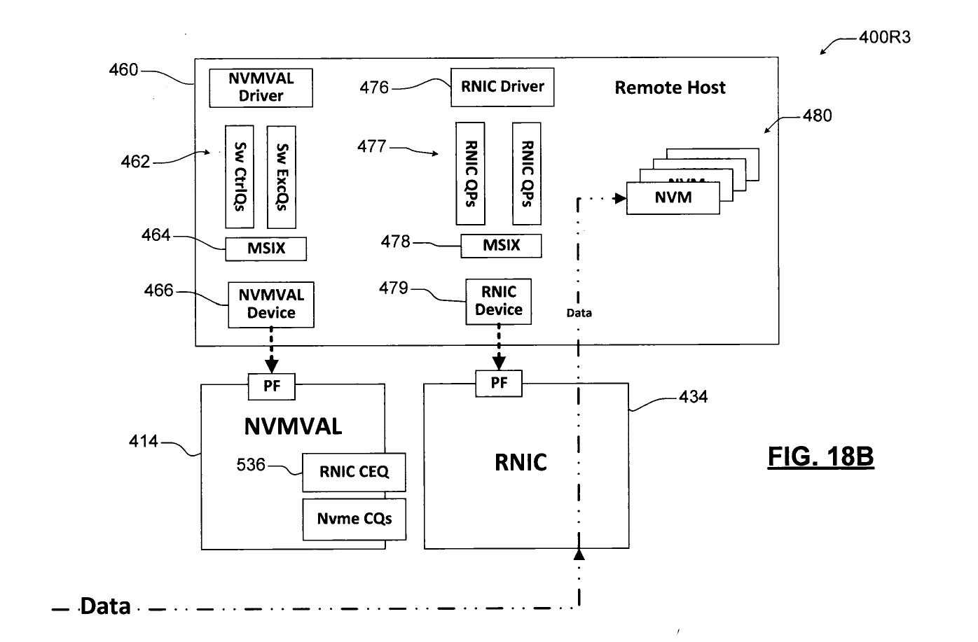

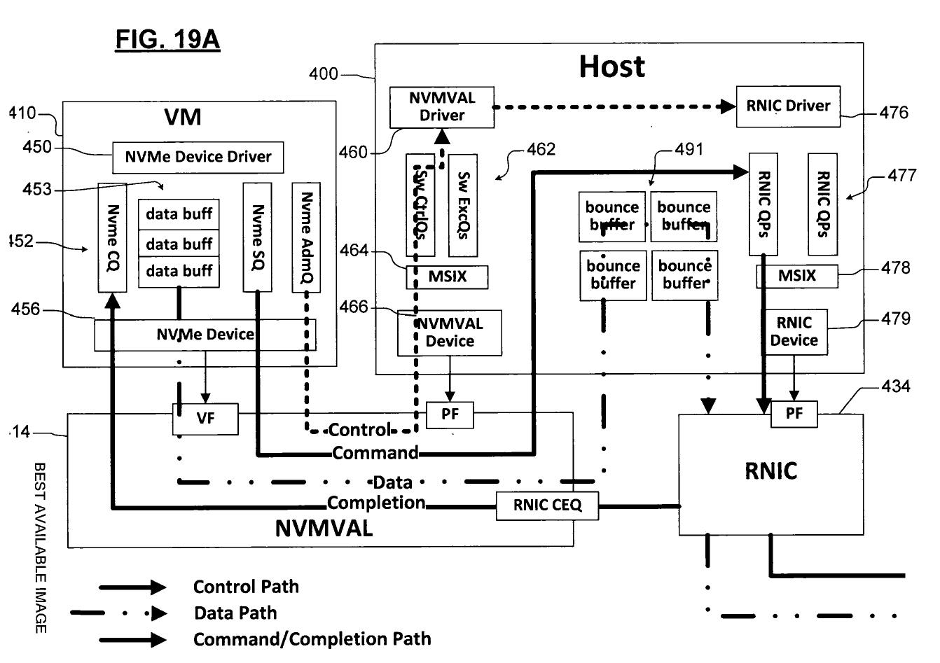

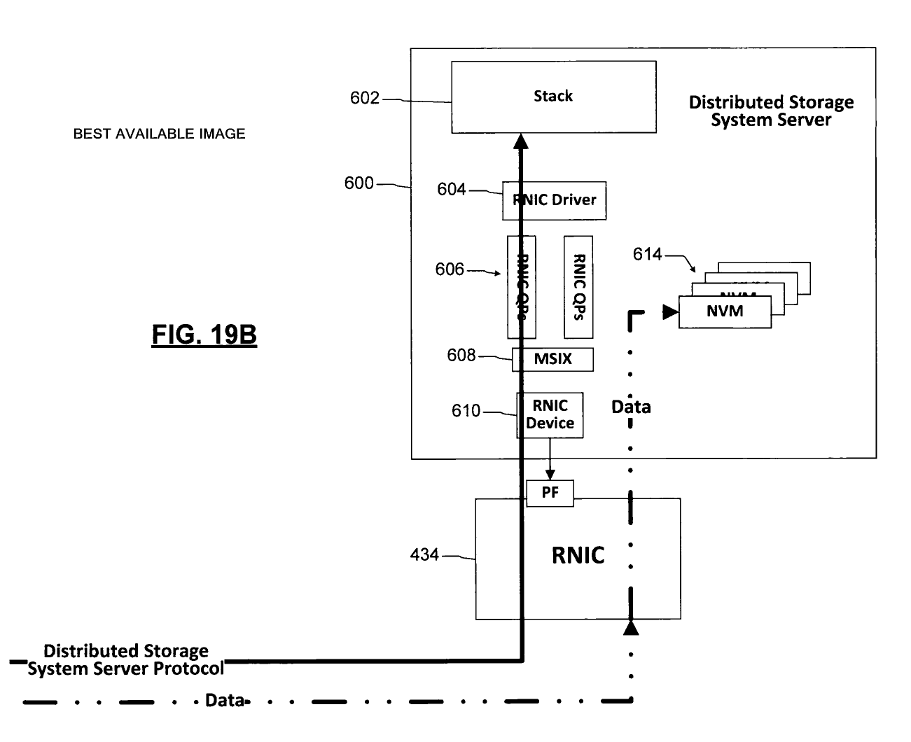

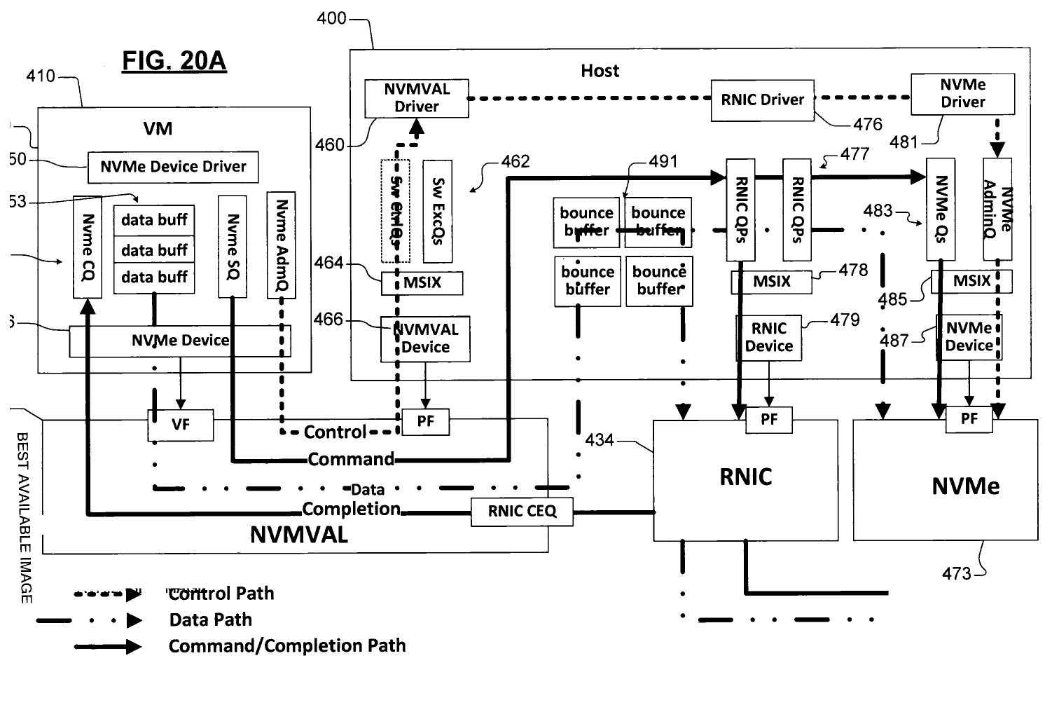

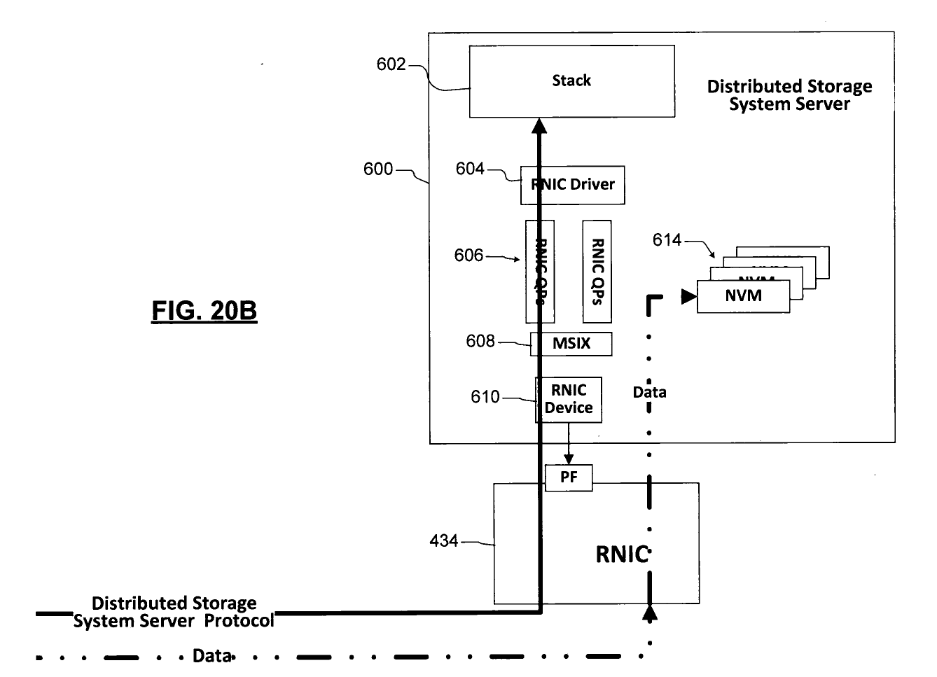

Referring now to FIGS. 19A-19B and 20A-20B, virtualized direct access to distributed storage system server back ends is shown. This model provides virtualization of the distributed storage platforms such as Microsoft Azure.

A distributed storage system server 600 includes a stack 602, RNIC driver 604, RNIC Qs 606, MSIX 608 and RNIC device interface 610. The distributed storage system server 600 includes NVM 614. The NVMVAL hardware device 414 in FIG. 22A implements data path operations of the client end-point of the distributed storage system server protocol. The control operation is implemented by the NVMVAL driver 460 in collaboration with the stack 602.

The NVMVAL hardware device 414 interprets disk read and disk write commands posted to the NVMe SQs 452 exposed directly to the VM 410, translates those to the respective commands of the distributed storage system server 600, resolves the distributed storage system server 600, and sends the commands to the distributed storage system server 600 for the further processing.

The NVMVAL hardware device 414 reads and processes VM data (encryption, CRC), and makes the data available for the remote access by the distributed storage system server 600. The distributed storage system server 600 uses RDMA reads or RDMA writes to access the VM data that is encrypted and CRC'ed by the NVMVAL hardware device 414, and reliably and durably stores data of the VM 410 to the multiple replicas accordingly to the distributed storage system server protocol.

Once data of the VM 410 is reliably and durably stored in multiple locations, the distributed storage system server 600 sends a completion message. The completion message is translated by the NVMVAL hardware device 414 to the NVMe CQ 452 in the VM 410.

The NVMVAL hardware device 414 uses direct hardware communication with the RNIC 434 to communicate with the distributed storage system server 600. The NVMVAL hardware device 414 is not deployed on the distributed storage system server 600 and all communication is done using the remote RNIC 434 of the remote host computer 400R3. In some examples, the NVMVAL hardware device 414 uses a wire protocol to communicate with the distributed storage system server 600.

A virtualization unit of the distributed storage system server protocol is virtual disk (VDisk). The VDisk is mapped to the NVMe namespace exposed by the NVMVAL hardware device 414 to the VM 410. Single VDisk can be represented by multiple distributed storage system server slices, striped across different distributed storage system servers. Mapping of the NVMe namespaces to VDisks and slice resolution is configured by the distributed storage system server management stack via the NVMVAL driver 460 and performed by the NVMVAL hardware device 414.

The NVMVAL hardware device 414 can coexist with a software client end-point of the distributed storage system server protocol on the same host computer and can simultaneously access and communicate with the same or different distributed storage system servers. Specific VDisk is either processed by the NVMVAL hardware device 414 or by software distributed storage system server client. In some examples, the NVMVAL hardware device 414 implements block cache functionality, which allows the distributed storage system server to take advantage of the local NVMe storage as a write-thru cache. The write-thru cache reduces networking and processing load from the distributed storage system servers for the disk read operations. Caching is an optional feature, and can be enabled and disabled on per VDisk granularity.

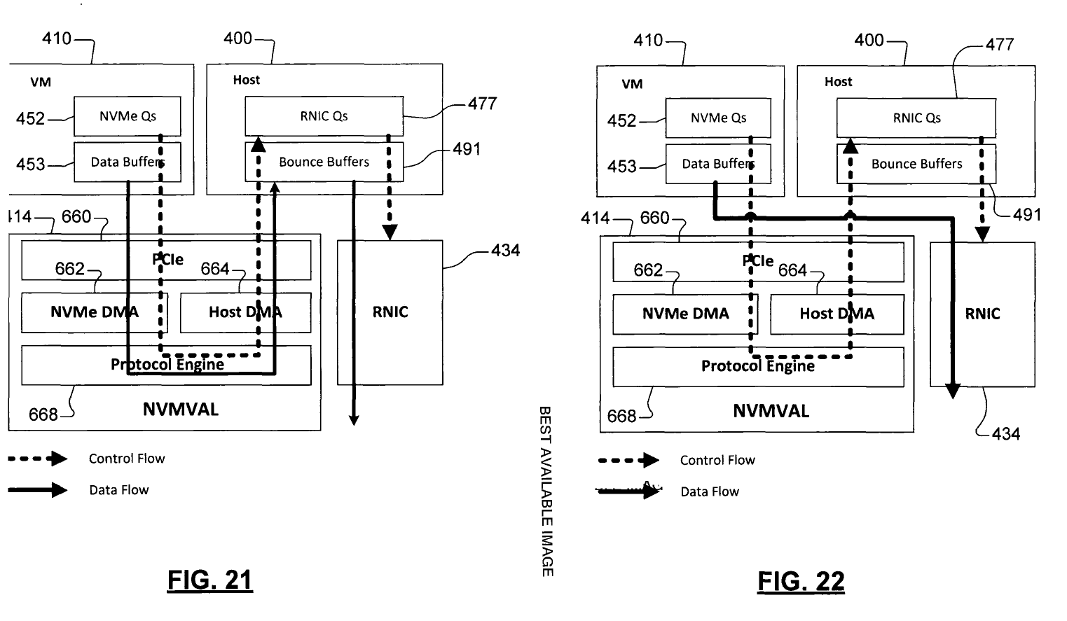

Referring now to FIGS. 21-24, examples of integration models are shown. In FIG. 21, a store and forward model is shown. The bounce buffers 491 in the host computer 400 are utilized to store-and-forward data to and from the VM 410. The NVMVAL hardware device 414 is shown to include a PCIe interface 660, NVMe DMA 662, host DMA 664 and a protocol engine 668. Further discussion of the store and forward model will be provided below.

In FIG. 22, the RNIC 434 is provided direct access to the data buffers 453 located in the VM 410. Since data does not flow thru the NVMVAL hardware device 414, no data processing by the NVMVAL hardware device 414 can be done in this model. It also has several technical challenges that need to be addressed, and may require specialized support in the RNIC 434 or host software stack/hypervisor (such as Hyper V).

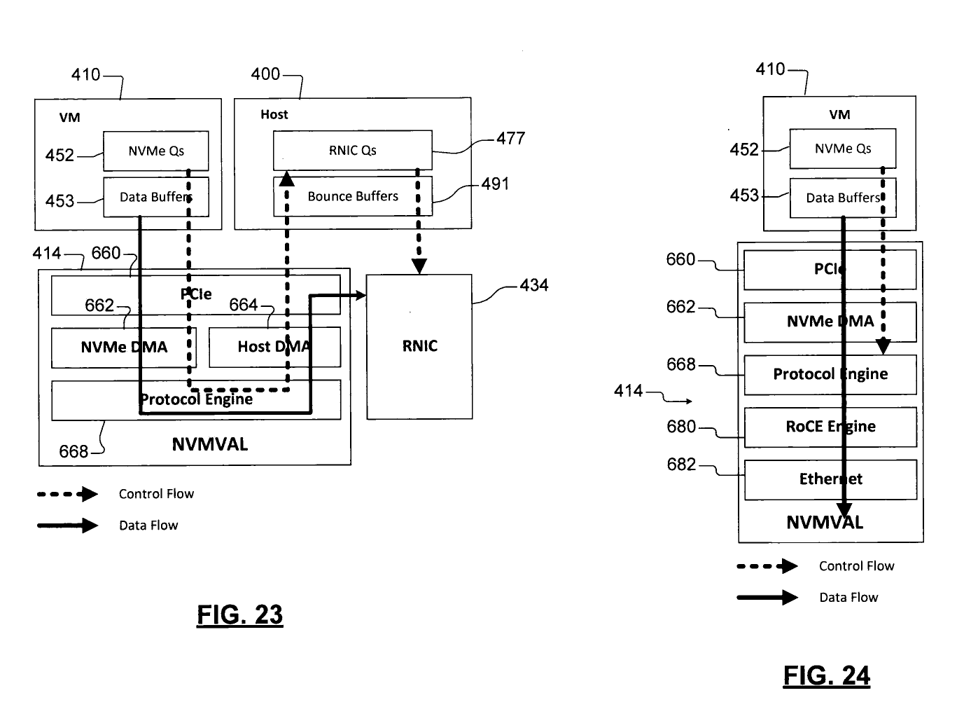

In FIG. 23, a cut-through model is shown. This peer-to-peer PCIE communication model is similar to the store and forward model shown in FIG. 21 except that data streamed thru the NVMVAL hardware device 414 on PCIE requests from the RNIC 434 or the NVMe device instead of being stored and forwarded through the bounce buffers 491 in the host computer 400.

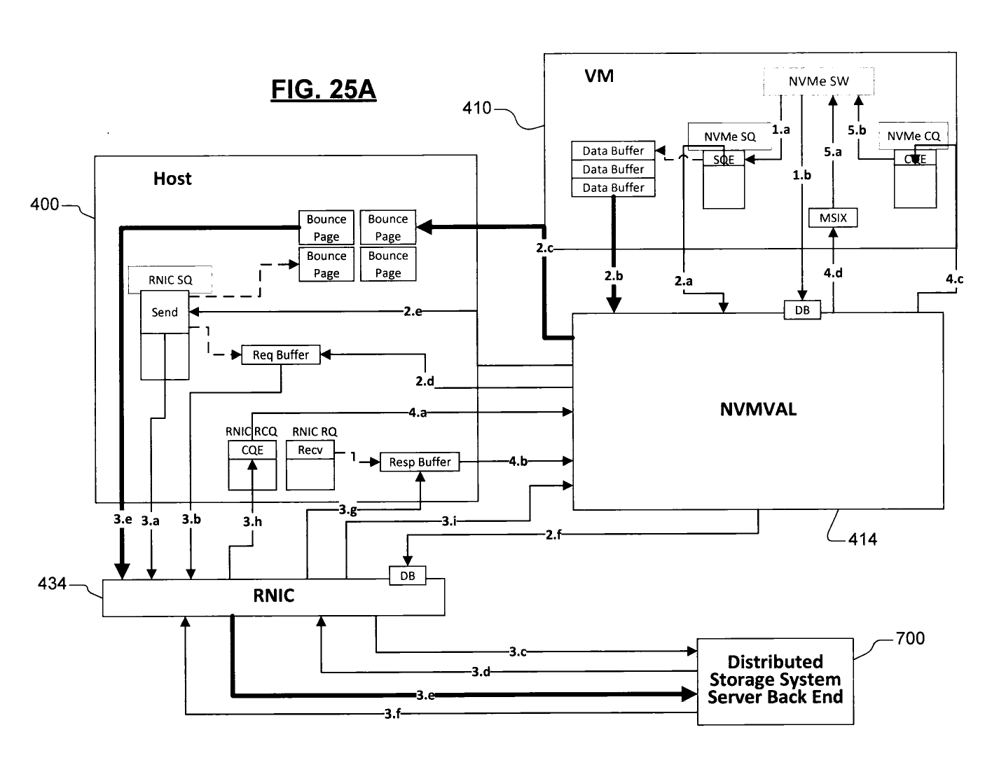

In FIG. 24, a fully integrated model is shown. In addition to the software components shown in FIGS. 21-23, the NVMVAL further includes a RDMA over converged Ethernet (RoCE) engine 680 and an Ethernet interface 682. In this model, complete integration of all components to the same board/ NVMVAL hardware device 414 is provided. Data is streamed thru the different components internally without consuming system memory or PCIE bus throughput.

In the more detailed discussion below, the RNIC 434 is used as an example for the locally attached hardware device that the NVMVAL hardware device 414 is directly interacting with.

Referring to FIG. 21, this model assumes utilization of the bounce buffers 491 in the host computer 400 to store-and-forward data on the way to and from the VM 410. Data is copied from the data buffers 453 in the VM 410 to the bounce buffers 491 in the host computer 400. Then, the RNIC 434 is requested to send the data from the bounce buffers 491 in the host computer 400 to the distributed storage system server, and vice versa. The entire IO is completely stored by the RNIC 434 to the bounce buffers 491 before the NVMVAL hardware device 414 copies data to the data buffers 453 in the VM 410. The RNIC Qs 477 are located in the host computer 400 and programmed directly by the NVMVAL hardware device 414.

This model simplifies implementation at the expense of increasing processing latency. There are two data accesses by the NVMVAL hardware device 414 and one data access by the RNIC 434.

For short IOs, the latency increase is insignificant and can be pipelined with the rest of the processing in NVMVAL hardware device 414. For the large IOs, there may be significant increases in the processing latency.

From the memory and PCIE throughput perspective, the NVMVAL hardware device 414 processes the VM data (CRC, compression, encryption). Copying data to the bounce buffers 491 allows this to occur and the calculated CRC remains valid even if an application decides to overwrite the data. This approach also allows decoupling of the NVMVAL hardware device 414 and the RNIC 434 flows while using the bounce buffers 491 as smoothing buffers.

Referring to FIG. 22, the RNIC direct access model enables the RNIC 434 with direct access to the data located the data buffers 453 in the VM 410. This model avoids latency and PCIE/memory overheads of the store and forward model in FIG. 21.

The RNIC Qs 477 are located in the host computer 400 and are programmed by the NVMVAL hardware device 414 in a manner similar to the store and forward model in FIG. 21. Data buffer addresses provided with RNIC descriptors are referring to the data buffers 453 in the VM 410. The RNIC 434 can directly access the data buffers 453 in the VM 410 without requiring the NVMVAL hardware device 414 to copy data to the bounce buffers 491 in the host computer 400.

Since data is not streamed thru the NVMVAL hardware device 414, the NVMVAL hardware device 414 cannot be used to offload data processing (such as compression, encryption and CRC). Deployment of this option assumes that the data does not require additional processing.

Referring to FIG. 23, the cut-through approach allows the RNIC 434 to directly access the data buffers 453 in the VM 410 without requiring the NVMVAL hardware device 414 to copy the data thru the bounce buffers 491 in the host computer 400 while preserving data processing offload capabilities of the NVMVAL hardware device 414.

The RNIC Qs 477 are located in the host computer 400 and are programmed by NVMVAL hardware device 414 (similar to the store and forward model in FIG. 21). Data buffer addresses provided with RNIC descriptors are mapped to the address space of the NVMVAL hardware device 414. Whenever the RNIC 434 accesses the data buffers, its PCIE read and write transactions are targeting NVMVAL hardware device address space (PCIE peer-to-peer). The NVMVAL hardware device 414 decodes those accesses, resolves data buffer addresses in VM memory, and posts respective PCIE requests targeting data buffers in VM memory. Completions of PCIE transactions are resolved and propagated back as completions to RNIC requests.

While avoiding data copy through the bounce buffers 491 and preserving data processing offload capabilities of the NVMVAL hardware device 414, this model has some disadvantages. Since all data buffer accesses by the RNIC 434 are tunneled thru the NVMVAL hardware device 414, latency of completion of those requests tends to increase and may impact RNIC performance (e.g. specifically latency of the PCIE read requests).

Referring to FIG. 24, in the fully integrated model, no control or data path goes through the host computer 400 and all control and data processing is completely contained within the NVMVAL hardware device 414. From the data flow perspective, this model avoids data copy through the bounce buffers 491 of the host computer 400, preserves data processing offloads of the NVMVAL hardware device 414, does not increase PCIE access latencies, and does not require a dual-ported PCIE interface to resolve write-to-write dependences. However, this model is more complex model than the models in FIGS. 21-23.

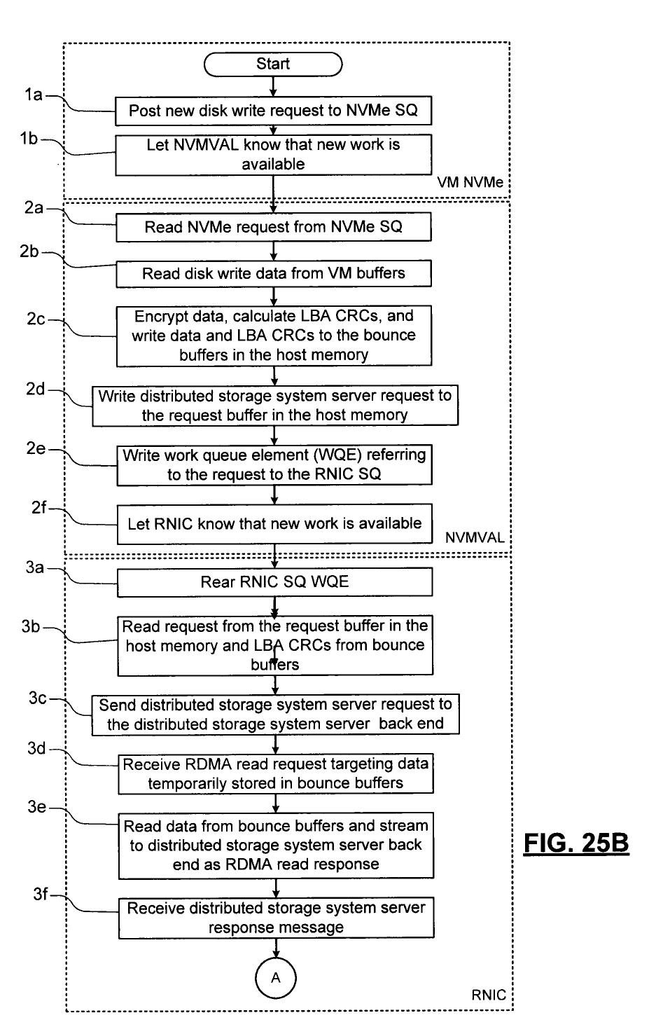

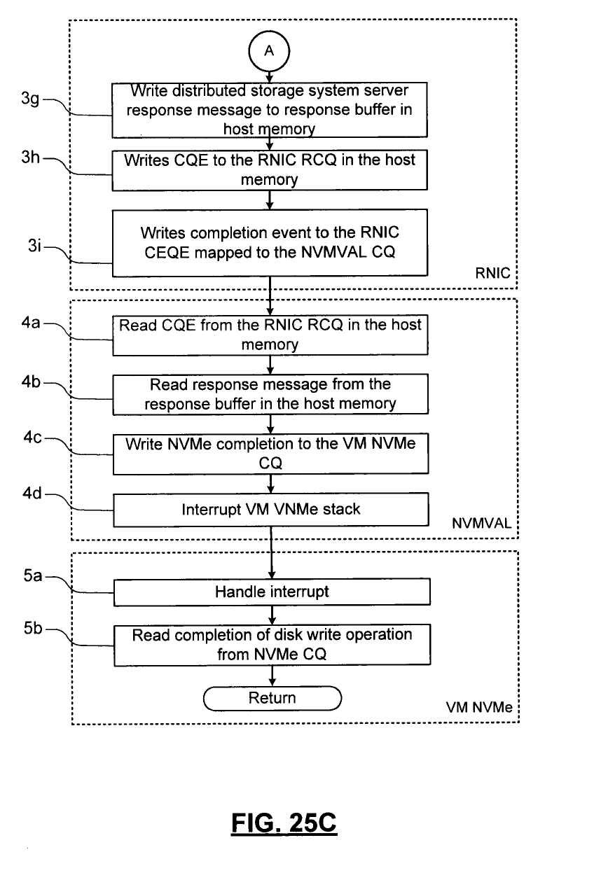

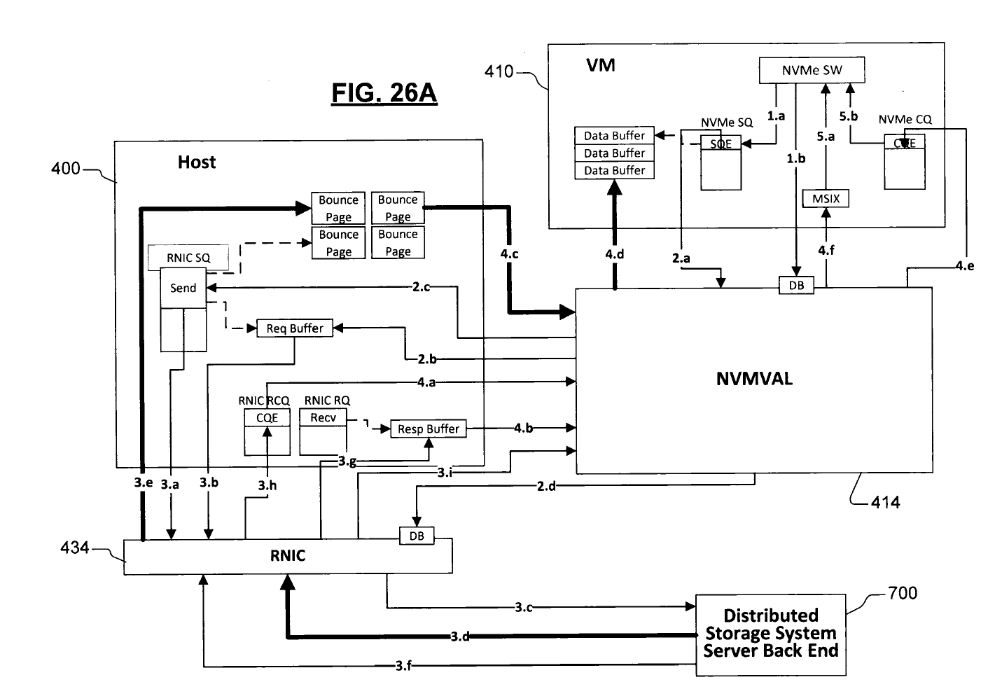

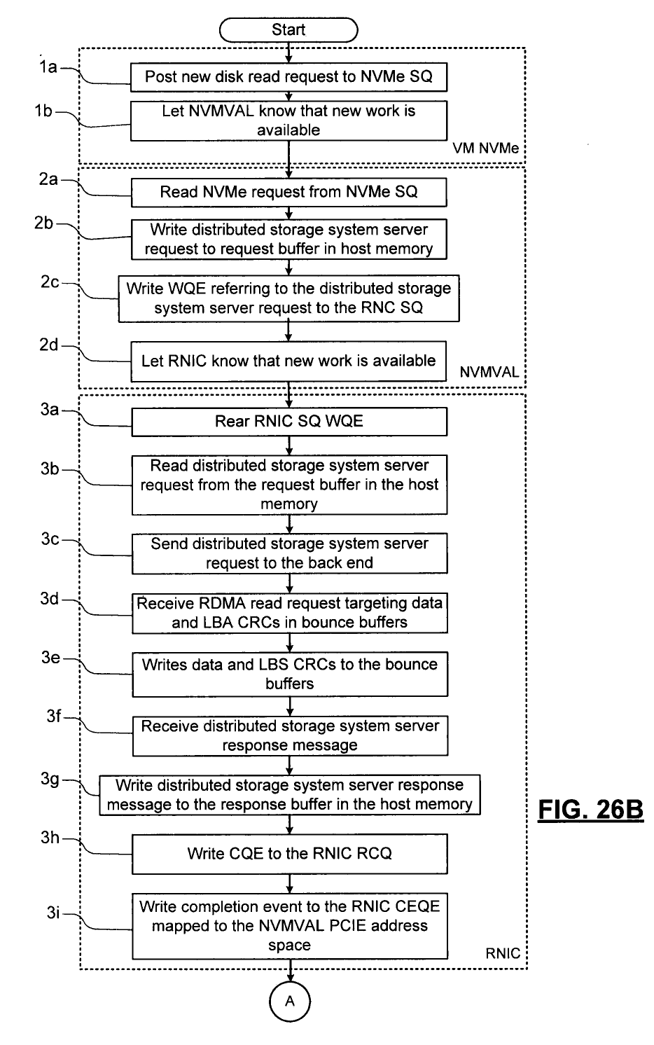

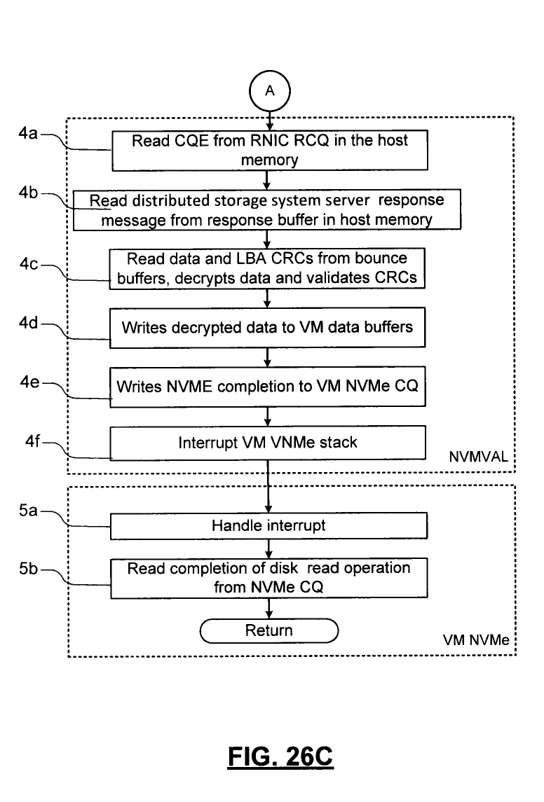

Referring now to FIGS. 25A to 25C and 26A to 26C, examples of the high level data flows for the disk read and disk write operations targeting a distributed storage system server back end storage platform are shown. Similar data flows apply for the other deployment models.

In FIGS. 25A to 25C, a simplified data flow assumes fast path operations and successful completion of the request. At 1a, the NVMe software in the VM 410 posts a new disk write request to the NVMe SQ. At 1b, the NVMe in the VM 410 notifies the NVMVAL hardware device 414 that new work is available (e.g. using a doorbell (DB)). At 2a, the NVMVAL hardware device reads the NVMe request from the VM NVMe SQ. At 2b, the NVMVAL hardware device 414 reads disk write data from VM data buffers. At 2c, the NVMVAL hardware device 414 encrypts data, calculates LBA CRCs, and writes data and LBA CRCs to the bounce buffers in the host computer 400. In some examples, the entire IO may be stored and forwarded in the host computer 400 before the request is sent to a distributed storage system server back end 700.

At 2d, the NVMVAL hardware device 414 writes a distributed storage system server request to the request buffer in the host computer 400. At 2e, the NVMVAL hardware device 414 writes a write queue element (WOE) referring to the distributed storage system server request to the SQ of the RNIC 434. At 2f, the NVMVAL hardware device 414 notifies the RNIC 434 that new work is available (e.g. using a DB).

At 3a, the RNIC 434 reads RNIC SQ WQE. At 3b, the RNIC 434 reads distributed storage system server request from the request buffer in the host computer 400 and LBA CRCs from CRC page in the bounce buffers 491. At 3c, the RNIC 434 sends a distributed storage system server request to the distributed storage system server back end 700. At 3d, the RNIC 434 receives a RDMA read request targeting data temporary stored in the bounce buffers 491. At 3e, the RNIC reads data from the bounce buffers and streams it to distributed storage system server back end 700 as a RDMA read response. At 3f, the RNIC 434 receives a distributed storage system server response message.

At 3g, the RNIC 434 writes a distributed storage system server response message to the response buffer in the host computer 400. At 3h, the RNIC 434 writes CQE to the RNIC RCQ in the host computer 400. At 3i, the RNIC 434 writes a completion event to the RNIC completion event queue element (CEQE) mapped to the PCIe address space of the NVMVAL hardware device 414.

At 4a, the NVMVAL hardware device 414 reads CQE from the RNIC RCQ in the host computer 400. At 4b, the NVMVAL hardware device 414 reads a distributed storage system server response message from the response buffer in the host computer 400. At 4c, the NVMVAL hardware device 414 writes NVMe completion to the VM NVMe CO. At 4d, the NVMVAL hardware device 414 interrupts the NVMe stack of the VM 410.

At 5a, the NVMe stack of the VM 410 handles the interrupt. At 5b, the NVMe stack of the VM 410 reads completion of disk write operation from NVMe

Referring now to FIGS. 26A to 26C, an example of a high level disk read flow is shown. This flow assumes fast path operations and successful completion of the request.

At 1a, the NVMe stack of the VM 410 posts a new disk read request to the NVMe SQ. At 1b, the NVMe stack of the VM 410 notifies the NVMVAL hardware device 414 that new work is available (via the DB).

At 2a, the NVMVAL hardware device 414 reads the NVMe request from the VM NVMe SQ. At 2b, the NVMVAL hardware device 414 writes a distributed storage system server request to the request buffer in the host computer 400. At 2c, the NVMVAL hardware device 414 writes WQE referring to the distributed storage system server request to the SQ of the RNIC 434. At 2d, the NVMVAL hardware device 414 notifies the RNIC 434 that new work is available.

At 3a, the RNIC 434 reads RNIC SQ WQE. At 3b, the RNIC 434 reads a distributed storage system server request from the request buffer in the host computer 400. At 3c, the RNIC 434 sends the distributed storage system server request to the distributed storage system server back end 700. At 3d, the RNIC 434 receives RDMA write requests targeting data and LBA CRCs in the bounce buffers 491. At 3e, the RNIC 434 writes data and LBA CRCs to the bounce buffers 491. In some examples, the entire IO is stored and forwarded in the host memory before processing the distributed storage system server response, and data is copied to the VM 410.

At 3f, the RNIC 434 receives a distributed storage system server response message. At 3g, the RNIC 434 writes a distributed storage system server response message to the response buffer in the host computer 400. At 3h, the RNIC 434 writes CQE to the RNIC RCQ.

At 3i, the RNIC 434 writes a completion event to the RNIC CEQE mapped to the PCIe address space of the NVMVAL hardware device 414.

At 4a, the NVMVAL hardware device 414 reads CQE from the RNIC RCQ in the host computer 400. At 4b, the NVMVAL hardware device 414 reads a distributed storage system server response message from the response buffer in the host computer 400. At 4c, the NVMVAL hardware device 414 reads data and LBA CRCs from the bounce buffers 491, decrypts data, and validates CRCs. At 4d, the NVMVAL hardware device 414 writes decrypted data to data buffers in the VM 410. At 4e, the NVMVAL hardware device 414 writes NVMe completion to the VM NVMe CO. At 4f, the NVMVAL hardware device 414 interrupts the NVMe stack of the VM 410.

At 5a, the NVMe stack of the VM 410 handles the interrupt. At 5b, the NVMe stack of the VM 410 reads completion of disk read operation from NVMe CQ.

The foregoing description is merely illustrative in nature and is in no way intended to limit the disclosure, its application, or uses. The broad teachings of the disclosure cap be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term code, as used above, may include software, firmware, and/or microcode, and may refer to programs, routines, functions, classes, data structures, and/or objects. The term shared processor circuit encompasses a single processor circuit that executes some or all code from multiple modules. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as JSON (JavaScript Object Notation), HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCamI, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A host computer, comprising
a virtual machine including a device-specific nonvolatile memory interface (NVMI);
a nonvolatile memory virtualization abstraction layer (NVMVAL) hardware device communicating with the device-specific NVMI of the virtual machine; and
a NVMVAL driver executed by the host computer and communicating with the NVMVAL hardware device,
wherein the NVMVAL hardware device advertises a local NVM device to the device-specific NVMI of the virtual machine, and
wherein the NVMVAL hardware device and the NVMVAL driver are configured to virtualize access by the virtual machine to remote NVM that is remote from the virtual machine as if the remote NVM is local to the virtual machine.

2. The host computer of claim 1, wherein the NVMVAL hardware device and the NVMVAL driver are configured to mount a remote storage volume and to virtualize access by the virtual machine to the remote storage volume.

3. The host computer of claim 2, wherein the NVMVAL driver requests location information from a remote storage system corresponding to the remote storage volume, stores the location information in memory accessible by the NVMVAL hardware device and notifies the NVMVAL hardware device of the remote storage volume.

4. The host computer of claim 2, wherein the NVMVAL hardware device and the NVMVAL driver are configured to dismount the remote storage volume.

5. The host computer of claim 1, wherein the NVMVAL hardware device and the NVMVAL driver are configured to write data to the remote NVM.

6. The host computer of claim 5, wherein the NVMVAL hardware device accesses memory to determine whether or not a storage location of the write data is known, sends a write request to the remote NVM if the storage location of the write data is known and contacts the NVMVAL driver if the storage location of the write data is not known.

7. The host computer of claim 1, wherein the NVMVAL hardware device and the NVMVAL driver are configured to read data from the remote NVM.

8. The host computer of claim 7, wherein the NVMVAL hardware device accesses memory to determine whether or not a storage location of the read data is known, sends a read request to the remote NVM if the storage location of the read data is known and contacts the NVMVAL driver if the storage location of the read data is not known.

9. The host computer of claim 1, wherein the NVMVAL hardware device performs compression and encryption using customer keys and generates cyclic redundancy check data.

10. The host computer of claim 1, wherein the NVMI comprises a nonvolatile memory express (NVMe) interface.

11. The host computer of claim 1, wherein the NVMI performs device virtualization.

12. The host computer of claim 1, wherein the NVMI comprises a nonvolatile memory express (NVMe) interface with single root input/output virtualization (SR-IOV).

13. The host computer of claim 1, wherein the NVMVAL hardware device notifies the NVMVAL driver when an error condition occurs, and wherein the NVMVAL driver uses a protocol of the remote NVM to perform error handling.

14. The host computer of claim 13, wherein the NVMVAL driver notifies the NVMVAL hardware device when the error condition is resolved.

15. The host computer of claim 1, wherein the NVMVAL hardware device includes:
a mount/dismount controller to mount a remote storage volume corresponding to the remote NVM and to dismount the remote storage volume;
a write controller to write data to the remote NVM; and
a read controller to read data from the remote NVM.

16. The host computer of claim 4, wherein an operating system of the host computer includes a hypervisor and host stacks, and wherein the NVMVAL hardware device bypasses the hypervisor and the host stacks for data path operations.

17. The host computer of claim 1, wherein the NVMVAL hardware device comprises a field programmable gate array (FPGA).

18. The host computer of claim 1, wherein the NVMVAL hardware device comprises an application specific integrated circuit.

19. A host computer, comprising
a virtual machine including a device-specific nonvolatile memory interface (NVMI);
a nonvolatile memory virtualization abstraction layer (NVMVAL) hardware device communicating with the device-specific NVMI of the virtual machine; and
a NVMVAL driver executed by the host computer and communicating with the NVMVAL hardware device,
wherein the NVMVAL hardware device advertises a local NVM device to the device-specific NVMI of the virtual machine, and
wherein the NVMVAL driver handles control path processing for read requests from the remote NVM from the virtual machine and write requests to the remote NVM from the virtual machine, and
wherein the NVMVAL hardware device handles data path processing for the read requests from the remote NVM for the virtual machine and the write requests to the remote NVM from the virtual machine.

20. A host computer, comprising
a virtual machine including a device-specific nonvolatile memory interface (NVMI);
a nonvolatile memory virtualization abstraction layer (NVMVAL) hardware device communicating with the device-specific NVMI of the virtual machine; and
a NVMVAL driver executed by the host computer and communicating with the NVMVAL hardware device,
wherein the NVMVAL hardware device advertises a local NVM device to the device-specific NVMI of the virtual machine, and
wherein the NVMVAL hardware device handles data path processing for the read requests from the remote NVM for the virtual machine and the write requests to the remote NVM from the virtual machine and wherein the NVMI comprises a nonvolatile memory express (NVMe) interface with single root input/output virtualization (SR-IOV).
